(19) United States
(12) Patent Application Publication
(10) Pub. No.: US 2008/0249667 A1
(43) Pub. Date: Oct. 9, 2008

(54) LEARNING AND REASONING TO ENHANCE ENERGY EFFICIENCY IN TRANSPORTATION SYSTEMS

(75) Inventors: Eric J. Horvitz, Kirkland, WA (US); John C. Krumm, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/733,701

(22) Filed: Apr. 10, 2007

Related U.S. Application Data
(60) Provisional application No. 60/910,799, filed on Apr. 9, 2007.

(51) Int. Cl. G06F 19/00

(52) U.S. Cl. 701/1; 701/209

(57) ABSTRACT

There is employment of machine learning, reasoning, and optimization included in a multi-attribute utility framework to learn and control energy systems to enhance the efficiency of vehicles. This can include energy systems included in vehicles that employ multiple energy sources. There is construction of models that provide inferences given historical information and/or real-time sensing of contextual information that are used in optimization. Such inferences about such key uncertainties as that route being taken are used in optimizing the expected utilities.

### CROSS-REFERENCE TO RELATED APPLICATIONS

This application claims the benefit of Provisional U.S. Patent Application Ser. No. 60/910,799, filed Apr. 9, 2007, entitled LEARNING AND REASONING TO ENHANCE ENERGY EFFICIENCY IN TRANSPORTATION SYSTEMS, the entirety of which is incorporated herein by reference.

This application is related to co-pending U.S. patent application Ser. No. 11/426,540, filed on Jun. 26, 2006, and entitled METHODS FOR PREDICTING DESTINATIONS FROM PARTIAL TRAJECTORIES EMPLOYING OPEN-AND CLOSED-WORLD MODELING METHODS. The entirety of which is incorporated herein by reference.

This application is related to co-pending U.S. patent application Ser. No. 11/428,225, filed on Jun. 30, 2006, and entitled METHODS AND ARCHITECTURE FOR LEARNING AND REASONING IN SUPPORT OF CONTEXT-SENSITIVE REMINDING, INFORMING, AND SERVICE FACILITATION. The entirety of which is incorporated herein by reference.

This application is related to co-pending U.S. patent application Ser. No. 11/428,228, filed on Jun. 30, 2006, and entitled METHODS AND ARCHITECTURES FOR CONTEXT-SENSITIVE REMINDERS AND SERVICE FACILITATION. The entirety of which is incorporated herein by reference.

### TECHNICAL FIELD

The subject specification relates generally to operation policies and in particular to creating efficient energy policies for vehicle thrust.

### BACKGROUND

In recent years, environmental issues have become a major concern. Many political and social debates take place to resolve a host of issues concerning the environment. One issue of importance is depletion of non-renewable natural resources, such as crude oil and its product gasoline. Fossil fuels are used to power many of the world's vehicles; however, since fossil fuel resources are largely non-renewable, there will come a time when the availability and pricing of this resource makes it use in inappropriate in many situations. Not only are fossil fuels like gasoline scarce resources, but the combustion of fossil fuel in transportation systems creates as a byproduct gases that are harmful to the environment, some of which threaten the peak and mean temperatures around the planet because of their greenhouse properties. Some recent developments have centered on alternate energy sources that mitigate some of the problems associated with fossil fuels.

Specifically, many developments have taken place concerning alternative fuels for automobiles. Conventionally, many automobiles are powered with fossil fuel through a spark-excited or diesel-powered internal combustion engine; however, there are small amounts of power produced from other sources, such as an internal battery. Research for alternative fuels for automobiles have focused on hybrid vehicles that use standard gasoline or diesel fuel combined with an alternative power source (e.g., electricity, natural gas, alcohol-based fuels, bio-diesel . . . ). The amount of fuel used by an automobile can be determined by specific characteristics associated with respective parts of the automobile. For example, the amount of gasoline burned by a conventional automobile in general is a function of physical size of the internal combustion engine as well as size of the automobile. Accordingly, there has been and continues to be significant efforts made toward understanding such relationships in connection with optimizing fuel consumption and utilization thereof.

### SUMMARY

The following presents a simplified summary of the specification in order to provide a basic understanding of some aspects of the specification. This summary is not an extensive overview of the specification. It is intended to neither identify key or critical elements of the specification nor delineate the scope of the specification. Its sole purpose is to present some concepts of the specification in a simplified form as a prelude to the more detailed description that is presented later.

Automobiles can use different types of stored energy to perform various operations, including propulsion operations. For example, hybrid vehicles consume both gasoline and electricity for power; however, consumption of fuel by hybrids is not always efficient. A common issue relating to inefficient fuel utilization is that it is not known how the vehicle will be operated and/or what route the vehicle will take. The subject specification is directed at operation policies for automobiles that allow for an efficient consumption of fuel and automobile resources. There are several manners in which an efficient operation policy is created.

One manner of creating an efficient operation policy is estimating route and destination the automobile will take. Based on the estimated route and destination, an operation policy can be created that is tailored to an anticipated route. The policy can be based on a plurality of parameters (e.g., traffic conditions, upcoming terrain, proximity to fuel or charging stations, costs of fuel or alternative energy source, user goals and needs, distance, departure and arrival times, driving characteristics of respective drivers, characteristics of respective automobiles . . . ) relating to the estimated route. Accordingly, the operation policy can adaptively tailor an energy utilization (e.g., fuel, electricity, or combination thereof) based on known, or expected parameters in connection with optimizing energy utilization and user goals and needs.

The following description and the annexed drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates a representative operation policy creation system in accordance with an aspect of the subject specification.

FIG. 2 illustrates a representative operation policy creation system with route devices in accordance with an aspect of the subject specification.

FIG. 3 illustrates a representative operation policy creation system with a reinforcement processor in accordance with an aspect of the subject specification.

FIG. 4 illustrates a representative set of sensors in accordance with an aspect of the subject specification.

FIG. 5 illustrates a representative communication sensor in accordance with an aspect of the subject specification.

FIG. 6 illustrates a representative operation policy creation system with a check component in accordance with an aspect of the subject specification.

FIG. 7 illustrates a representative operation policy creation system with a feedback component in accordance with an aspect of the subject specification.

FIG. 8 illustrates a representative operation policy creation system with a policy manipulation component in accordance with an aspect of the subject specification.

FIG. 9 illustrates a representative operation policy creation system with a login component in accordance with an aspect of the subject specification.

FIG. 10 illustrates a representative operation policy creation system with a recommendation component in accordance with an aspect of the subject specification.

FIG. 11a illustrates a first part of a representative operation of disclosed principles in accordance with an aspect of the subject specification.

FIG. 11b illustrates a second part of a representative operation of disclosed principles in accordance with an aspect of the subject specification.

FIG. 11c illustrates a third part of a representative operation of disclosed principles in accordance with an aspect of the subject specification.

FIG. 11d illustrates a fourth part of a representative operation of disclosed principles in accordance with an aspect of the subject specification.

FIG. 12 illustrates a representative operation policy creation system with a scheme component in accordance with an aspect of the subject specification.

FIG. 13a illustrates a first part of a representative methodology in accordance with an aspect of the subject specification.

FIG. 13b illustrates a second part of a representative methodology in accordance with an aspect of the subject specification.

FIG. 14 illustrates an example of a schematic block diagram of a computing environment in accordance with the subject specification.

FIG. 15 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. As another example, an interface can include I/O components as well as associated processor, application, and/or API components.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Many vehicles consume resources using a standard operating policy that dictates how the resources will be consumed. This means that resources are used with little regard as to the specific operation the automobile will go through. It would be more efficient to have a policy that is specifically directed at how the automobile will operate. The subject specification discloses creation of operation policies for a vehicle without explicitly knowing what the vehicle will encounter (e.g., not knowing what roads the vehicle will take). This is done by estimating the route the vehicle will use and using records of past operation of the vehicle to predict how the vehicle will operate in the future.

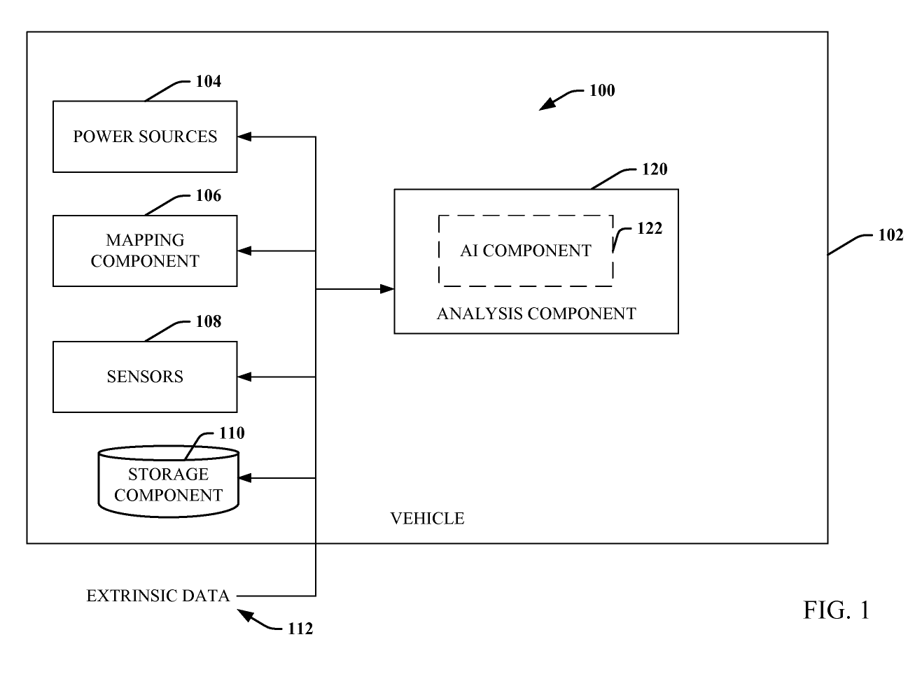

FIG. 1 discloses an example system 100 that facilitates efficient transportation when a route is unknown. A vehicle (e.g., automobile, motorcycle, boat, airplane, etc . . . ) 102 is depicted that can have various power sources 104. For example, the vehicle 102 can be powered by gasoline, electricity, natural gas, hydrogen, a hybrid of two or more compounds, etc. A mapping component 106 provides information in connection to an expected route of travel, optional routes, terrain, etc. It is to be appreciated the mapping component 106 can optionally be integrated with a global positioning system (GPS), traffic forecasting or information system or service, weather conditions, emergency information, and other suitable sources of information germane to travel. Sensors 108 (e.g., engine, internal and external temperature, tire pressure, tire wear, terrain sensors, vibration, noise, air quality, power meters, fuel sensors, energy levels, energy utilization, user stress, user feedback, voice recognition, facial recognition, gesture recognition, language parsers, text input etc.) are employed to collect information relating to the vehicle 102, a driver, passengers, environment, etc.

A storage component 110 stores information output by the power sources 104, mapping component 106, sensors 110, extrinsic information 112, as well as historical data (e.g., driving history, vehicle characteristics, user patterns, user habits, user characteristics, etc.). The storage component 110 also stores operation policies as well as models (explicitly or implicitly trained) that facilitate optimizing energy utilization, vehicle utilization, user goals, and user needs.

An analysis component 120 receives and processes information from the aforementioned components and the extrinsic data. The analysis component selects and applies respective policies in connection with optimizing power source utilization, vehicle utilization, user goals, and user needs or preferences. For example, if the vehicle 102 is a hybrid automobile powered by both fuel (e.g., gasoline, alcohol, bio-diesel, diesel, gasohol, combination thereof . . . ), as well as electrical energy stored in a storage cell, the vehicle 102 can use different amounts of energy resources (e.g., fuel and stored energy) at different times to meet certain criteria (e.g., optimizing power source utilization, vehicle utilization, user goals, user needs, user preferences, etc.). Thrust for the vehicle 102 is governed by a subset of policies, where the subset of policies dictate how the power sources 104 are employed to convert stored energy into thrust. Different nuances on operation of the vehicle 102 can create specific situations that dictate efficient policy management. It will be appreciated that certain types of storage cells operate more efficiently if fully discharged, within bounds that take into consideration battery longevity, prior to recharge. Accordingly, optimization of such cells would involve a policy that provides for respective cells to discharge significantly prior to recharge. When traveling up a hill, a planning and optimization system could commit to drawing power from the storage cell so as to commit it a significant quantity of its electrical power to climb the hill, therefore using little or no gasoline fuel; and when the vehicle 102 thereafter travels down the hill, the storage cell could recharge more efficiently than if it had not allocated its power during the climb. However, this policy would not be ideal when traveling up a plateau where there would not be a decline, and thus an opportunity to charge, for a long period of time. Without a decline, the vehicle 102 would need to use a large quantity of gasoline in order to complete recharge of the storage cell in addition to powering the vehicle 102. Accordingly, as discussed in greater detail infra, information regarding upcoming terrain (e.g. location of hills, plateaus, level of incline, etc.) can be leveraged via the mapping component 106 in connection with selection and employment of energy source utilization. For example, if it is determined or inferred with a high level of confidence that a lengthy decline follows an approaching hill, the operation policy would utilize most if not all energy to climb the hill from the cell (rather than fuel) knowing that the cell can be recharged during the lengthy decline.

The analysis component 120 can utilize a set of models (e.g., driver behavior model, vehicle model, terrain model, energy source model, etc.) in connection with determining or inferring which set of policies to apply given a current set of events. The models can be based on a plurality of information (e.g., driver behavior, vehicle performance, predicted and/or sensed traffic flow speeds, etc . . . The optimizations can harness a model that is trained from previously collected data, a model that is based on a prior model that that is updated with new data, via model mixture or data mixing methodology, or simply one that is trained with seed data, and thereafter tuned in real-time by training with actual field data during use and non-use of the vehicle as well as with different drivers, and operating conditions. Over time, the respective models will become trained to facilitate optimizing vehicle, energy, and user utilization/goals.

An optional learning and reasoning system, referred to as the AI component 122, can be employed by the analysis component 120 in connection with making determinations or inferences regarding optimization decisions and the like. The AI component 122 can employ for example, a probabilistic-based or statistical-based approach in connection with making determinations or inferences. The inferences can be based in part upon explicit training of classifier(s) (not shown) before employing the system 100, or implicit training based at least upon a vehicle's, or user's previous actions, commands, instructions, and the like during use of the system. Data or policies used in optimizations can be collected from specific drivers or from a community of drivers and their vehicles.

The AI component 122 can employ one of numerous methodologies for learning from data and then drawing inferences from the models so constructed (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein.

Methods also include methods for the capture of logical relationships such as theorem provers or more heuristic rule-based expert systems. Inferences derived from such learned or manually constructed models can be employed in optimization techniques, such as linear and non-linear programming, that seek to maximize some objective function. For example, maximizing the overall efficiency of a vehicle's energy systems, minimizing the fuel expenses, or maximizing a richer multi-attribute utility model taking into consideration efficiencies, fuel costs, numbers of stops, maintenance costs (e.g., based in battery lifespans associated with different discharge policies), and so on.

The optimization policies can take into consideration inferences about destinations and routes considered under uncertainty, including the details of associated discharge opportunities and regenerative and downhill charging opportunities ahead, availability of explicit power sources as charging opportunities, traffic patterns, whether all of the latter are deterministic or uncertain, given.

The AI component 122, can take into consideration historical data, and data about the current context, such as the recently observed trajectories and velocities of a vehicle, calendar information, time of day and day of week, state of the vehicle and its energy subsystems, state and intentions of the user (inferred or asserted explicitly), state of a highway or more global road system, etc. and can compute the expected utilities of different energy policies. Such policies consider including the consideration of the cost of making an incorrect determination or inference versus benefit of making a correct determination or inference. Accordingly, an expected-utility-based analysis can be used to provide inputs or hints to other components or for taking automated action directly. Ranking and confidence measures can be calculated and employed in connection with such analysis.

For example, the cost of making an incorrect decision regarding power source utilization given great distance to a fueling or charging station would equate to a driver being stranded on a remote road with low or no cellular telephone coverage. Such costs can be factored into decisions made by the analysis component 120 as part of the optimization process.

The analysis component 120 can also employ policies that optimize power source utilization as well as cost thereof. For example, if the mapping component 106 identifies location of and distance to various fueling and charging stations, and the extrinsic data (e.g., provided over the Internet) includes price of fuel at each station and cost of charging cells as charging stations, the analysis component 120 may opt for a policy that provides for less efficient power source utilization given long-term benefit (e.g., using the cells for operation of the vehicle 102 at high speeds because a free charging station is 10 miles ahead, and the driver's schedule indicates that he has free time to stop by the station for a recharge, and he can grab a low cost lunch at the restaurant next to the station). In view of the foregoing example, it will be appreciated that optimization is dynamic and policies selected and implemented will vary as a function of the numerous parameters (e.g., power source utilization, user state, user goals, user preferences, costs, efficiency, available time, schedules, environment, vehicle wear and tear, traffic, accessibility, distance to fueling stations, distance to charging stations, terrain, vehicle state, emergencies, . . . ); and thus the analysis component 120 is adaptive.

The analysis component 120 can take into consideration terrain information from terrain maps through indexing of global positioning system information. One consideration can be near-term, local terrain and context. Another consideration can be information (e.g., direct information, inferred information, etc.) about longer-term routes, up to and including a destination. For example, the analysis component 120 can consider a map of a possible route that can from a global positioning system in determining an operation policy. That can include both information of nearby terrain as well as information about terrain that will be encountered in a relatively long distance.

According to another embodiment, at least some of the displayed devices are not within the vehicle. These devices could be in a unit that attaches and communicates to the vehicle 102 through a port (e.g., an mp3 port). Furthermore, the devices can be in a location independent from the vehicle (e.g., a central location that communicates with the vehicle 102). For example, there could be separate companies that compete to deliver the best operating policies for a vehicle. These policies could be delivered as installed devices in the vehicle or services available via a network. The analysis component 120 can receive possible policies from the companies and evaluate which policy should be used. The company that provides the selected policy could be credited for providing a used policy.

While general energy efficiency is discussed, this can be only one area of information that can be taken into consideration for analysis of an operation policy. A multi-attribute utility model can consider effectiveness of power systems along with other factors. For example, there can also be consideration of the lifespan of a battery. In this example, for a particular battery, completely discharging a battery before recharging can be highly efficient, but it could cause the battery to only last six months.

If a battery is an expensive item (e.g., $5,000 replacement for a $20,000 new vehicle), then that consideration should be taken into account for optimizing utilization of the power sources. It could be detrimental to optimize energy efficiency alone when there are financial constraints that should be taken into account by the analysis component 120. Therefore, optimizing utilization of the power sources can be directed to information related to energy efficiency and optimizing utilization of the power sources can take into account multiple attributes (e.g., cost and energy efficiency).

There can be other types of information that relate to optimizing utilization of power sources. For example, there can be changes in speed laws (e.g., a law stating traveling on a highway limits automobiles to fifty-five miles per hour or less), a route, a distance of a journey, a time until destination, etc.). Based on a plurality of information, the analysis component 120 can determine a policy based on at least two attributes. For example, the analysis component 120 can consider both efficient operation as well as minimal damage a power source 104.

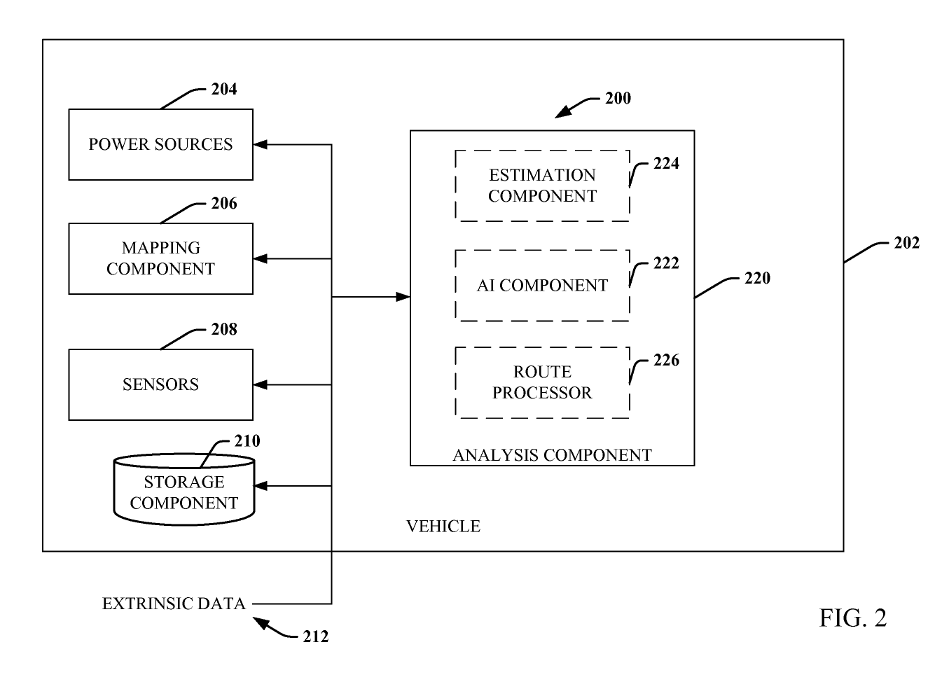

FIG. 2 discloses an example system 200 for efficient transportation based on an estimated route. A vehicle 202, commonly a hybrid vehicle, powered by various power sources 204 is depicted. A mapping component 206 gives information as to what route and destination the vehicle 202 will take. For example, the mapping component 206 can estimate that at 5pm on a weekday, a vehicle located in a downtown urban area will travel to a garage where it is common for the vehicle 202 to be placed (e.g., a route that travels from an operator's work to an operator's home).

Sensors 208 collect a variety of information relating to the vehicle 202. Records of sensed information can be saved in a storage component 210. Furthermore, information relating to other components can be saved in the storage component 210. Extrinsic information 212 can also enter the vehicle and the extrinsic information 212 is saved in the storage component 210. The storage component 210 can also be used to hold information for progressive learning (e.g. information about how the vehicle is predicted to be operated).

An analysis component 220 obtains and processes information from previously mentioned components and extrinsic data. The analysis component can employ an artificial intelligence component 222 in making determinations or inferences for optimizing operations, including operation policy. For making determination or inferences, the analysis component 220 can use an estimation component 224. An estimation component 224 uses information from the mapping component 206. For example, the mapping component 206 can transfer maps to the estimation component 224. The estimation component then makes an approximation as to the route the vehicle 202 is likely to take. According to another embodiment, the estimation component 224 can integrate with the mapping component 206.

The analysis component 220 can use a route processor 226 in analysis of data and application of a set of policies. The route processor 226 allows for the application of a vehicle operation policy as a function of expected travel route. For example, it can be known when a hill will be encountered during an estimated route; a policy can be applied to the vehicle 202 that allows a storage cell to discharge while climbing a hill and re-charge while the vehicle 202 is descending the hill. While this shows an example of a specific policy on a hill, it is to be appreciated that a policy can be far more complex while taking into account an array of information (e.g. working with a detailed model of end-to-end propulsion and energy storage system).

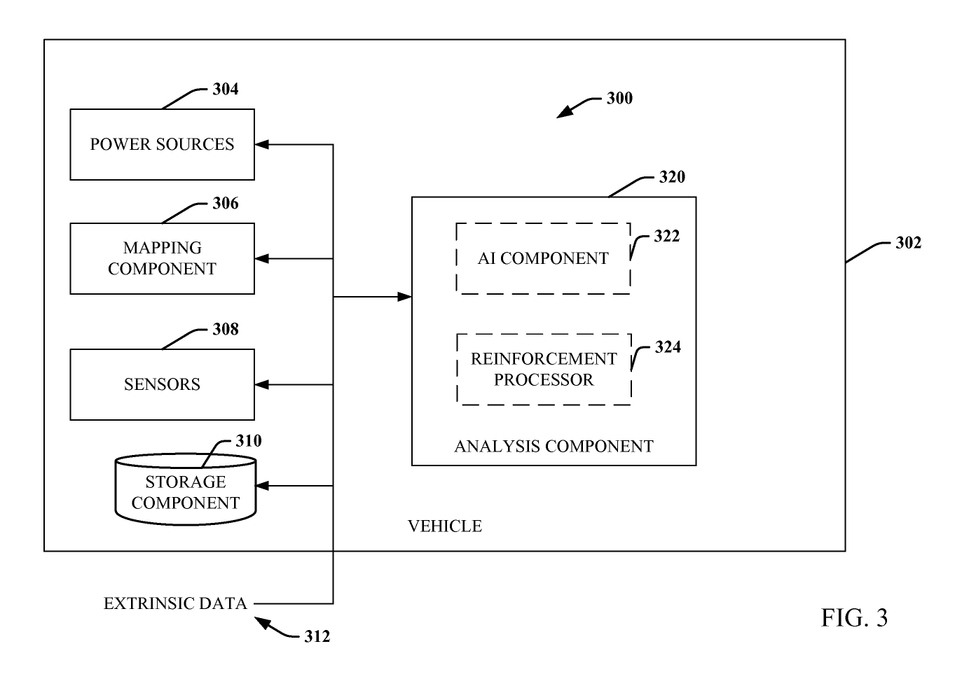

FIG. 3 discloses an example system 300 for efficient transportation based on previous engagements of a vehicle 302. The vehicle 302, commonly a hybrid vehicle, powered by various power sources 304 (e.g. fuel and power sources in a hybrid vehicle, etc . . . ) is depicted with a plurality of components and devices. While these components and devices are shown as part of the vehicle, it is to be appreciated that at least some of the components and devices can attach separately to the vehicle 302. Furthermore, some components can be in a location separate from the vehicle 302. For example, storage and processing can take place at a central server. A mapping component 306 can attempt to estimate a route and destination that will be taken by the vehicle 302.

Sensors 308 perceive information that relates to the operation of the vehicle, including environmental information, usage information, parameter information, etc. A storage component 310 can hold copies of sensed information for later use as well as information from other related devices or components. Extrinsic information 312 can also enter the vehicle (e.g., sensed through the sensors 308, feed into communication system of the vehicle, delivered to an analysis component 320, etc . . . ) and be saved in the storage component 310. The storage component 310 can also be used to hold information that relates to how the vehicle has operated in the past.

An analysis component 320 can function to analyze collected data (e.g., data obtained by sensors 308, extrinsic data 312, data located in the storage component 310, etc.). Analysis of collected data allows for the application of a set of policies for optimized performance (e.g., efficient fuel and resource usage) for the vehicle 302. To make a determination or inference as to what policies should be applied, the analysis component 320 can use an artificial intelligence component 322. Using the artificial intelligence component 322, there can use different types of analysis to make inferences or determinations.

In addition, in making a determination or inference as to what polices should be applied to power sources 304 of the vehicle 302, the analysis component 320 can use a reinforcement processor 324 for making the determination or inference. The reinforcement processor 324 can attempt to learn characteristics about operation of the vehicle 302 and implement policies based on what has been learned. For example, a salesperson can sell ship anchors during business hours of weekdays. The salesperson's vehicle 302 can have a different weight depending on what day and time the vehicle 302 is engaged. Therefore, the reinforcement processor 324 can learn the history of the use of the vehicle 302 and create efficient policies based on expected uses.

In accordance with another embodiment, the reinforcement processor 324 determines or infers an operation policy based on common usage of the vehicle 302. Many automobiles are modeled with general characteristics in mind. For example, the average person in a nation can weigh 60 Kilograms (KG). A manufacturer can design an automobile policy for operation with a 60 KG person. However, the operator of one automobile can weigh 120 KG. Due to the difference in weight, the automobile can operate differently and thus require a different operation policy for improved efficiency.

The reinforcement processor 324 can determine that the weight in the vehicle 302 is more then what was expected and the policy should be changed. This allows the reinforcement processor 324 adaptively learn information and adjust operation policies accordingly. However, this is still based on an unknown. It is possible that a spouse of the 120 KG operator can also use the vehicle 302 with the spouse weighing 50 KG. Therefore, the policy is applied with a general estimation on the weight of the operator.

In a further embodiment, an operator can have personal operation characteristics. For example, an operator can have a tendency to operate a vehicle 302 at speeds well below posted speed limits. The reinforcement processor 324 can create a policy that modifies fuel usage to create an efficient operation of the vehicle 302. While several embodiments are disclosed, it is to be appreciated that the reinforcement processor 324 can apply policies from a variety of different information derived from a number of different sources.

In yet a further embodiment, the reinforcement processor 324 can learn information concerning outside characteristics of the vehicle 302. For example, there can be a large amount of difference in traffic patterns between New York City, N.Y. and Boise, Id. The reinforcement processor 324 can learn what types of traffic patterns in which the vehicle 302 engages. Based on common traffic patterns in which the vehicle 302 engages, the reinforcement processor 324 can implement an efficient operation policy for the vehicle 302.

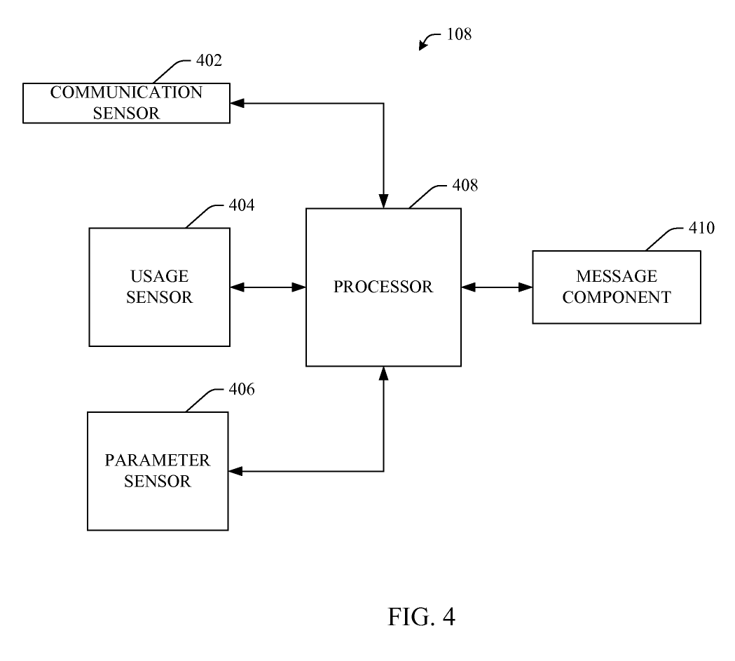

FIG. 4 discloses an example set of sensors 108 that can be used: a communication sensor 402, a usage sensor 404, and a parameter sensor 406. A communication sensor 402 gathers information from outside the vehicle 102 that could be of importance to efficient operation of the vehicle 102. Information from outside influences can have a large impact on route and destination estimation as well as policy determination. For example, a vehicle 102 can be located in a downtown area. The communication sensor 402 can gather information that a baseball game has just finished and the vehicle 102 is near a stadium where the game was played. Therefore, the communication sensor 402 can gather information such as how many people were at the game, what roads they will likely travel, and what construction is taking place on the roads.

A usage component 404 collects information relating to a particular operation of the vehicle 102. For example, an operator of the vehicle 102 has a specific weight that can influence consumption of vehicle resources. Information commonly sensed by the usage component 404 is dependent on a current operation of the vehicle 102. (e.g., the next time the vehicle is operated; there can be a different operator with a different weight).

In another embodiment, the reinforcement processor can track the details of the potentially changing properties of a chemical or other energy storage system with age or usage. For example, a battery charging and discharging profile, per efficiencies, voltages, current flows, storage capacities, etc. can change with the age and usage of the subsystem. A learning system can adapt policies by tracking the storage and release profile of energy capture systems.

A parameter sensor 406 gathers information relating to the physical operation of the vehicle 102. This is commonly information as to how the vehicle 102 functions is collected, which is less dependent on current operations as information sensed by the usage sensor 404. For example, after the vehicle 102 is operated a number of times, there can be a change in the internal friction of moving parts of the vehicle 102. The change in internal friction can change how to operate efficiently the vehicle 102 and knowledge of the friction change can be useful in policy determination.

A processor 408 can obtain sensed information and perform operations on the sensed information. When sensed information is communicated to other devices of the vehicle 102, it can be beneficial for the information to be organized and processed to make the sensed information easier to use. The processor 408 can perform a plurality of operations upon sensed information.

According to one embodiment, the processor 408 can organized sensed information so information that is most commonly used by other components can be easily accessed. In another embodiment, the processor 408 compresses information so it can stored in less space. In a further embodiment, the processor 404 can selectively transfer information that is commonly relevant to other components. For example, the usage sensor 404 can sense what the atmospheric pressure is inside a cabin of the vehicle. However, it is possible this information has not yet had an impact on what policy is used to operate the vehicle. Therefore, the processor 408 can disregard this information or not send this information unless it is explicitly requested.

A message component 410 can allow for information communication with the analysis component 120 of FIG. 1 or with other components disclosed herein. The message component 410 transfers processed information to the analysis component where the processed information is utilized in policy decisions. The message component 410 can operate in a number of different embodiments. According to an embodiment, sensors operate continuously to supply as much accurate data as possible. According to another embodiment, sensors collect data prior to the implementation of policies. Once policies are implemented, the sensors stop functioning or operate with limited functionality in order to conserve vehicle energy.

The message component 410 can also be configured to correspond with other devices, including device outside of a vehicle 102 of FIG. 1. For example, a database server can collect information for vehicles of a certain type (e.g., Honda Civic Hybrids). The database server can send an instruction to the message component 410 to collect parameter information. The message component 410 can employ available sensors to collect information requested by the database server and transmit the data to an appropriate location.

An instruction from a database server can include information of other vehicles of the same type and how they operate. For example, an operator of a vehicle 102 of FIG. 1 can live in Kansas where there can be few hills encountered by the vehicle 102 of FIG. 1. However, the operator can take a trip to Colorado, where there are likely a number of hills that will be encountered. Since the operated vehicle 102 of FIG. 1 has not encountered many hills, there could be inadequate information for determining an efficient operation policy. Therefore, the analysis component 120 of FIG. 1 can employ information from other similar vehicles that have encountered hills since it is likely the vehicle 102 of FIG. 1 will function in a significantly similar manner to like vehicles.

The message component 410 can also function as part of the control of other devises shown in FIG. 4. For example, the sensors 402, 404, and 406 can configure to operate only when they are so instructed. The message component 410 can receive a request that the sensors 402, 404, and 406 begin obtaining information. The processor 408 can perform a check on the request for authentication purposes. Once authenticated, the sensors can begin normal functionality.

While FIG. 4 discloses an example set of sensors 108, it is to be appreciated that this is not the only available sensor configuration, and any suitable set of sensors can be employed in accordance with aspects described herein. Furthermore, a set of sensors can relate to sensors themselves and/or sensors and support devices (e.g., processor, message component, etc . . . ), as well as other configurations and combinations.

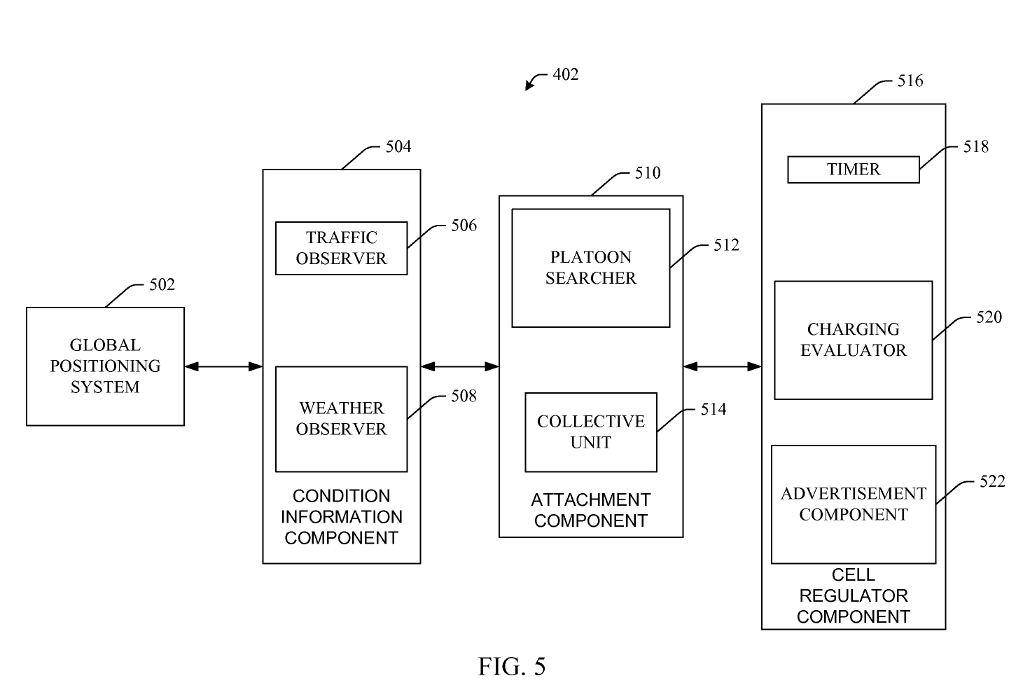

FIG. 5 discloses an example communication sensor 402. A plurality of information can be relevant for determining an efficient operating policy for use by a vehicle 102. The communication sensor 502 attempts to gather as much relevant information as possible in order to apply an efficient operating policy.

A global positioning system 502 determines location of the vehicle 102. According to one embodiment, the global positioning system 502 communicates with satellites to triangulate the position of the vehicle 102. Global positioning data can also be used to determine general characteristics of a path that can be taken by a vehicle 102. For example, the global positioning system 502 can not only find location of the vehicle 102, but also find a location of a home of an operator in relation to a position of the vehicle 102.

Furthermore, the global positioning system 502 can determine altitude characteristics. For example, a storage call can operate efficiently when it completely discharges prior to recharging. Therefore, it can be useful to know where a vehicle 102 is located. If there is an area with many hills, then there could be multiple opportunities to discharge and recharge a storage cell.

A condition information component 504 can communicate to collect data about the environment in which a vehicle 102 can travel. According to one embodiment, the condition information component 504 can have a traffic observer 506. The traffic observer 502 can determine traffic patterns surrounding the vehicle 102. For example, the vehicle 102 can be in a location with few other cars. Therefore, unexpected stopping can be less likely to take place. Therefore, this information can be used to create a policy that allows fuels usage to follow more closely with the land (e.g., as opposed to following traffic patterns).

According to another embodiment, the traffic observer 502 can determine information relating to construction on roads. Construction conditions can change the operation of a vehicle 102. For example, there can be heavier traffic at construction zones and/or there can be a lower speed limit in these zones. Since the vehicle 102 can change operation while in a construction zone, this information can be important for implementation of an efficient operation policy.

According to another embodiment, the condition information component 504 can have a weather observer 508. Weather information can be used for application of an efficient operation policy in a number of different manners. For example, weather can have an impact on operation of the vehicle 102. Different temperatures can cause different parts of the vehicle 102 (e.g., fuel cells, engine, etc.) to operate differently. This information can assist in implementing a specific policy for based on weather conditions.

Weather information can also be used to determine information concerning traffic patterns. For example, if there is a heavy snowstorm, an operator of the vehicle 102 could need extra power when traveling down a hill for stability purposes. Furthermore, weather can have an impact on individual driving characteristics. For example, during a rainstorm, drivers can be more cautious which can lead to traffic congestion in some areas. It is to be appreciated that while the global positioning system 502 and the condition information component 504 are shown as part of the communication sensor 502, these items can integrate with other components and devices disclosed in the subject specification, such as the mapping component 106 of FIG. 1.

The communication sensor 502 can also include an attachment component 510. Vehicles 102 can combine in various capacities to assist one another. An attachment component 510 can gather information about cars assisting one another in a form of attachment. Furthermore, vehicles do not have to be of the same model (e.g., Volkswagen Jetta), brand (e.g., Mitsubishi), or vehicle to cooperate (e.g., an automobile and a motorcycle can assist one another through attachment). Attachment does not necessarily mean physical attachment, but a relationship where vehicles at least partially operate together.

A platoon searcher 512 gathers information about a platoon of vehicles. A number of vehicles can link together where there is a leader vehicle and at least one follower vehicle. The leader vehicle can direct a platoon while follower vehicles can operate with little to no involvement from an operator.

The platoon searcher 512 can operate in a number of different ways. According to one embodiment, the platoon searcher 512 gathers information about available platoons. It can then transfer this information to the analysis component 120 of FIG. 1 and a route can be implemented that utilizes platoons. Based on a route with platoons, the analysis component 120 of FIG. 1 can apply an operation policy utilizing platoons.

In a further embodiment, the platoon component 512 can gain information about a platoon that contains the vehicle 102. This information can be used to estimate a route and destination and a policy can be applied for the route and destination. In yet another embodiment, the platoon component 512 sends information to the storage component 110 about when an operator of the vehicle 102 enters into a platoon. Based on this information, the analysis component 120, integrated with the reinforcement processor 324, can execute a policy based on learned knowledge of an operator partaking in platoons.

There can be a number of advantages that can take place with entering a platoon. For example, having a number of cars lined in a row can decrease wind resistance and allow vehicles to travel more aerodynamically. Reduced wind resistance can impact how a car uses resources and thus possible platooning could be taken into account when determining an operation policy. Furthermore, it is possible that the analysis component 120 of FIG. 1 use at least part of the operation policy of a platoon lead vehicle.

The attachment component 510 can also have a collective unit 514. A collective unit 514 can gather information about other similar vehicles. For example, a number of similar vehicles (e.g., Lexus RX Hybrid manufactured at the same location) can have different experiences. This information can be gathered by the collective unit 514. Efficient policies about the vehicle 102 can be implemented based off information of other, similar vehicles.

A cell regulator component 516 can gather information relating to charging storage cells of the vehicle 102. There is commonly a timer 518. The timer 518 tracks the period it can take to reach a charging station. The timer component 518 can work in conjunction with the global positioning system 502 to determine charging locations. A charging evaluator 520 can determine the capabilities of charging locations. For example, one charging location can take one hour to charge storage cells of the vehicle 102 and another location can take one and a half hours to charge the storage cells.

Furthermore, the cell regulator component 516 can contain an advertisement component 522. The advertiser component 522 can operate in a number of different manners. According to one embodiment, there can be market opportunities in which a vehicle 102 operator can recharge storage cells. For example, there can be an advertisement that there is free charging if a user stops at a location; however, the location is a mall. It can take an hour to charge storage cells, so it is presumed that the operator of the vehicle 102 will spend the hour at the mall. This information can be used in conjunction with other gathered information, such as a personal profile of an operator of the vehicle 102 to apply an efficient policy. For example, if an operator enjoys golf as a hobby, then a policy can be executed on storage locations that offer a free re-charge in conjunction with a driving range.

According to another embodiment, the advertisement component 522 can operate in a similar manner to validated parking. An operator can stop at a mall that has a charging location. The advertisement component 522 can determine areas that have charging opportunities for free. However, the user must spend a specific amount of money (e.g., $25) at a store to receive a free charge. The advertisement component 522 can find these locations and the policy component 110 can apply policies based on interest of an operator.

In a further embodiment, the advertisement component 522 can gather information about different prices available for charging storage cells. It is to be appreciated that while the subject specification discusses recharging of storage cells, there can be other configurations. For example, the advertisement component 522 can gather information about different gasoline prices. Based on a comparison of prices against fuel usage, a policy can be executed by the analysis component 120 of FIG. 1 for the vehicle 102. While references were shown in FIG. 1, disclosed information can relate to other drawings of the subject specification. Furthermore, while devices, components, and the like shown in FIG. 5 are depicted as part of the communication sensor 402, it is to be appreciated that they can integrate into other devices in other drawings or stand as their own units.

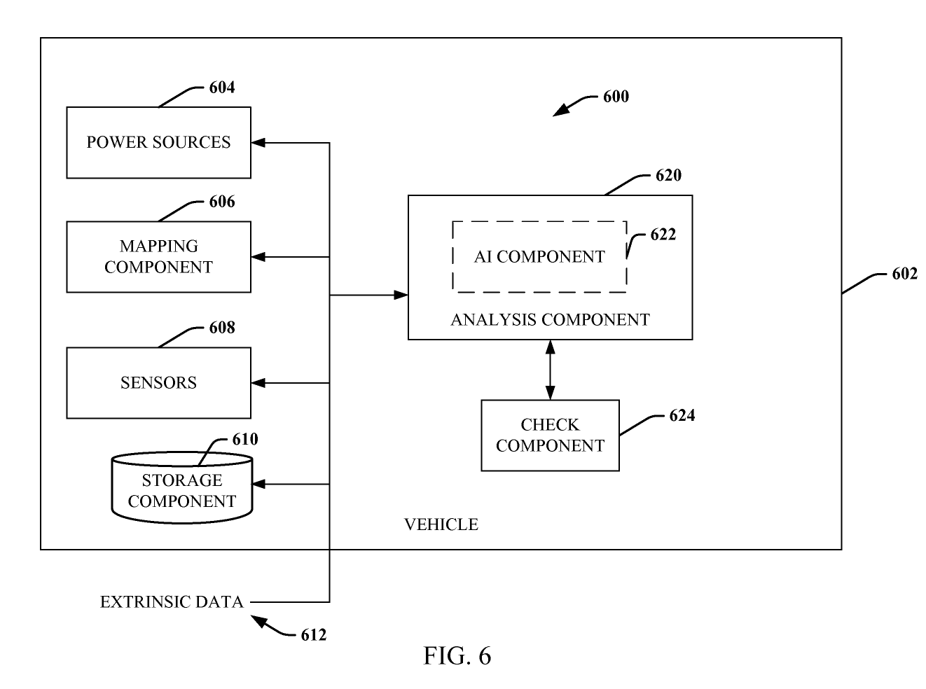

FIG. 6 discloses an example system 600 for policy implementation that allows for interaction from an operator of a vehicle 602. The vehicle 602, commonly a hybrid vehicle, is powered by power sources 604. A mapping component 606 can attempt to estimate a route and destination that will be taken by the vehicle 602. In order to travel on a route, the vehicle 602 commonly uses fuel that is stored in the power sources 604. However, there are some cases where a vehicle can travel on a route and not expend fuel (e.g., a moped bicycle traveling down a hill). A mapping component 606 can determine information relating to the route the vehicle can be likely to take.

Sensors 608 obtain data that relates to the operation of the vehicle 602 and obtained data is used to determine an operation policy for the vehicle 602. A storage component 610 holds information that relates to operation of the vehicle 602. Extrinsic information 612 can also enter the vehicle, have a log saved in the storage component 310, and used later to implement an operation policy for the vehicle 602. The storage component 610 can also be used to hold information that relates to how the vehicle has operated in the past.

An analysis component 620 can function to examine collected data for properties that can be important in implementing an operation policy for the vehicle 602. Once examined, the analysis component can have a more accurate picture as to how a vehicle 602 operates and thus how to implement policies to allow the vehicle 602 to operate at an increased efficiency. To make a determination or inference as to what policies should be applied, the analysis component 620 can use an artificial intelligence component 622. Using the artificial intelligence component 622, there can use different types of analysis to make the determination or inference.

A check component 602 determines if an operator of a vehicle 606 wants to engage in the operation policy. Using the check component 602, the operator can choose to allow the policy to function or deny the policy. If an acceptance of the policy takes place, then the policy can be implemented upon the vehicle 602.

If there is a denial of the policy, then several different functions can take place. According to one embodiment, a message can be sent to the power sources 604 that a denial took place. The power sources 604 can then function without following an efficiency policy and operate the vehicle 602 in a standard manner. In another embodiment, the sensors 608 can determine that the policy was denied. There can be an attempt at implementing another policy through the analysis component 620 that can again be checked by an operator. The check component 602 can configure that after a specific number of policies are denied (e.g., three policies), the power sources 604 operate without a policy specifically implemented for a current situation.

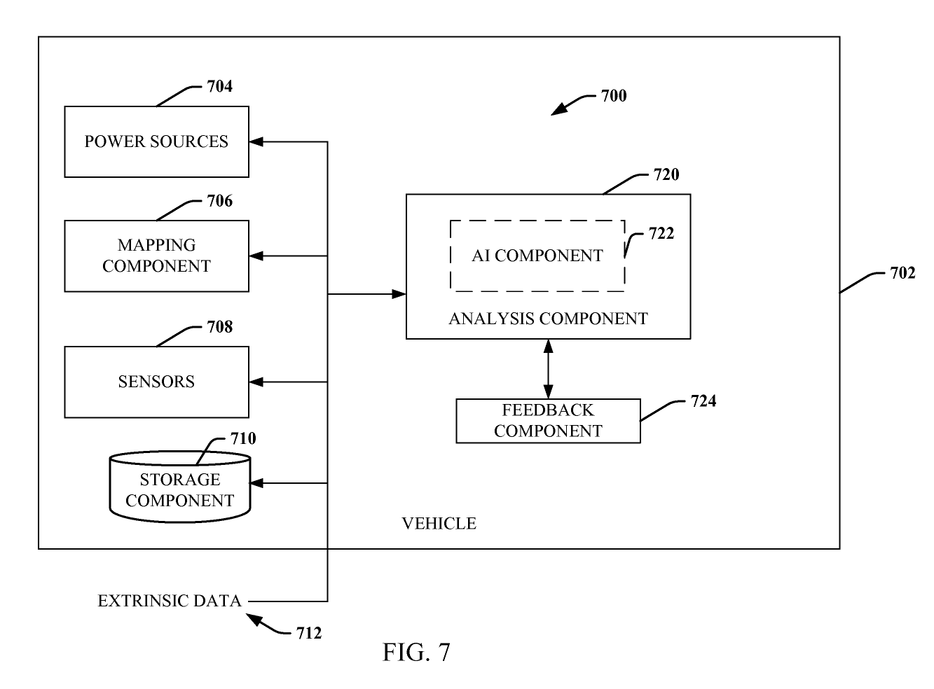

FIG. 7 discloses an example system 700 for determination of an efficient operation policy for a vehicle 702 with an ability to obtain feedback based on user reaction to an operation policy. The vehicle 702 powered by various power sources 704 is depicted. Typically, the vehicle is a hybrid vehicle that draws from at least two power sources 704 (e.g., gasoline and electricity). While components and devices are shown in FIG. 7 as part of the vehicle, it is to be appreciated that at least some of the components and devices can attach to the vehicle 702 without a need for permanent integration with the vehicle 702. A mapping component 706 gain information about a route that is expected to be taken by the vehicle 702 and/or determine the route the vehicle 702 will likely take.

Sensors 708 obtain a plurality of data types that can assist in determining an efficient policy for the vehicle 702 to operate. A storage component 710 holds details about data obtained by the sensors 708. The storage component 710 can hold information that relates to previous engagements of the vehicle 702. Extrinsic information 712 can also enter the vehicle 702 and be used to determine an efficient policy for operation.

An analysis component 720 can function to analyze data that has been obtained that relates to the determination of an operation policy. Based on analysis, the analysis component 720 determines an operation policy that can be used by the vehicle 702 in order to have an efficient user of vehicle 702 resources. In making determinations that relate to operation policies, the analysis component 720 can use an artificial intelligence component 722.

The operation policy travels to a feedback component 724. At the feedback component 724, the operator of the vehicle 702 can be presented with the operation policy. The operator can then select if they would like to use a presented policy. If the operator selects to use the policy, then the vehicle 702 can operate in accordance with the operation policy.

If the operator selects not to use the operation policy, then a record of this selection can be saved the storage component 710. The analysis component 720 can then attempt to create a new policy. Furthermore, when creating new policies, the system can take into account policies that were rejected by the operator at previous occurrences. This is similar to the check component 624 of FIG. 6, however, the feedback component allows for more interaction with the operator.

According to another embodiment, the feedback component 724 presents a user with a number of different policies in which to select. For example, a user can be presented with a policy that will allow the vehicle 702 to operate at peak efficiency, a policy that will allow the vehicle 702 to have maximum performance, and a policy that will allow the vehicle 702 to operate as cheaply as possible. The operator can select one of the polices and disregard the others.

The selected policy can be used by the power sources 704 of the vehicle 702. A record can be made in the storage component 710 of which policies were rejected. When creating future policies, the analysis component 720 can rely on the policies in which the operator has selected in the past.

In a further embodiment, a route is unable to be determined for the vehicle 702. A message travels to the feedback component 724 asking the operator of the vehicle 702 questions. For example, the feedback component 724 can ask a user if their driving ability will allow the vehicle 702 to be driven on a dirt road. The answer provided can be used by the mapping component 706 to determine an expected route and destination. In addition, answers to questions are saved in storage of the information collection component 708 for use in creating future policies.

In yet a further embodiment, the feedback component 724 can recommend routes to an operator of the vehicle 702. For example, if a user takes a specific route, it will take ‘X’ amount of time longer, but they will save ‘Y’ amount of fuel. The user can select the route and record can be made and used at a later time when estimating routes and creating policies (e.g., if a user selects a more efficient route, then the routes selected and policies created in the future can be designed with more efficiency in mind). An operator can also set limits for route estimation and policy creation. For example, the operator can instruct that no part of the route should have the vehicle 702 operate below ‘Z’ miles per gallon.

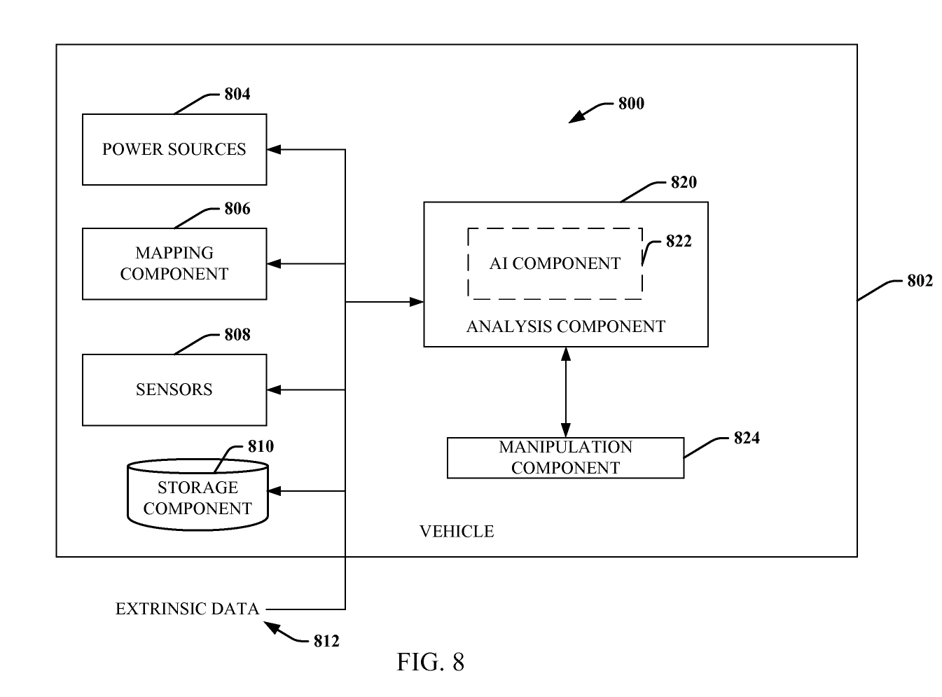

FIG. 8 discloses a system 800 for implementation of an efficient operation policy that allows for user manipulation of the policy. Thrust of a vehicle 802 is commonly performed by power sources 804 of the vehicle. The power sources 804 can be a variety of different sources and commonly employ a form of alternative energy. A mapping component 806 can gather information relating to an expected destination and route of the vehicle 802 and estimate a route in which the vehicle 802 will travel.

Sensors 808 gather information that relate to operation of the vehicle 802. A storage component 810 holds information relevant to determination of an operation policy for the vehicle 802. Extrinsic information 812 can also enter the vehicle 802 and be used in the determination of an efficient operation policy.

An analysis component 820 can function to evaluate collected data and based on the evaluation, an operation policy is determined or inferred for the vehicle 802. To make a determination or inference as to what policies should be applied, the analysis component 820 can use an artificial intelligence component 822. Using the artificial intelligence component 822, there can use different types of analysis to make the determination or inference

A manipulation component 824 allows a user to make specific changes regarding the operation policy that controls functionality of power sources 804. For example, a policy can be implemented that allows for maximum efficiency of operation of the vehicle 802. However, this policy could also reduce the amount of horsepower in the engine of the vehicle 802 by a percentage ‘X’. An operator can input data that an efficiency policy should be initiated to reduce horsepower by no less then ‘Y’ percentage.

The manipulation component 824 can operate in multiple manners. For example, the changes to the operation policy can be small, so changes are made on the operation policy and a changed operation policy travels to the power sources 804 for implementation. In another example, manipulation of the policy can be more extensive. Therefore, the policy can be sent back to the analysis component 820 and a new policy can be created.

According to another embodiment, the user can be asked a number of questions about a created policy. For example, there can be certain risk factors that can be analyzed. Risk factor analysis can take place for different risk types. In one example, a policy is presented that can allow for a change that a vehicle 802 possibly encounter a full energy failure (e.g., the vehicle runs out of gasoline). A user can manipulate a policy to ensure no route is selected that allows for a full energy failure. It is to be appreciated that the manipulation component 824 can function in different configurations. For example, a user can use the manipulation component 824 prior to the implementation of a policy. Therefore, when creating an operation policy, the analysis component 820 has information relating to the desires of the operator.

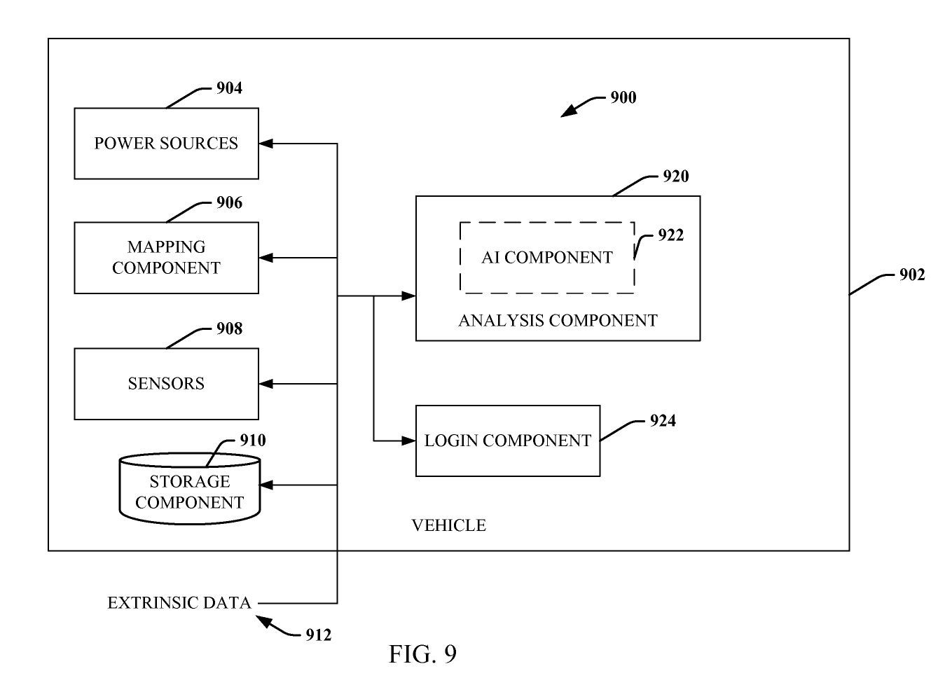

FIG. 9 discloses a system 900 for creation of an efficient operation policy that utilizes a profile of a specific operator of a vehicle. Vehicle 902 propulsion is commonly generated through power sources 904. The power sources 904 can be a variety of different sources and commonly employ a form of alternative energy. A mapping component 906 can gather information relating to an expected destination and route of the vehicle 902 and estimate a route in which the vehicle 902 will travel.

Sensors 908 gather information that relate to operation of the vehicle 902. A storage component 910 holds information relevant to determination of an operation policy for the vehicle 902. Extrinsic information 912 can also enter the vehicle 902 and be used in the determination of an efficient operation policy.

An analysis component 920 evaluates information that relates to the vehicle 902. Based on the evaluation of the information, there is a determination or inference on how to operate the power sources 904 for the vehicle 902. To make a determination or inference as to what policy or policies should be applied, the analysis component 920 can employ an artificial intelligence component 922.

When creating an efficient operation policy, it can be important to know what user is operating the vehicle 902. For example, user ‘A’ can have a tendency to operate the vehicle 902 at high performance levels while user ‘B’ is not comfortable operating the vehicle 902 on roads with a speed limit exceeding 50 miles per hour. Prior to creation of an operation policy, a user can enter identification information into the login component.

According to one embodiment, a login component 924 senses what user is operating the vehicle 902. This can be done in a number of different manners. For example, the weight of an individual in a driver's seat can signify which user is operating the vehicle 902. In another embodiment, the login component 924 can explicitly ask which user is operating the vehicle 902. An operation policy for the vehicle is determined or inferred by the analysis component 920.

The login component 924 can also configure to take into account more then just a single person entity into a vehicle 902. For example, the login component 924 can determine information about multiple people in an automobile. In this example, user ‘A’ can operate an automobile in one manner when a passenger is a spouse and in another manner when the passenger is a child and a third manner when the passenger is a family pet.

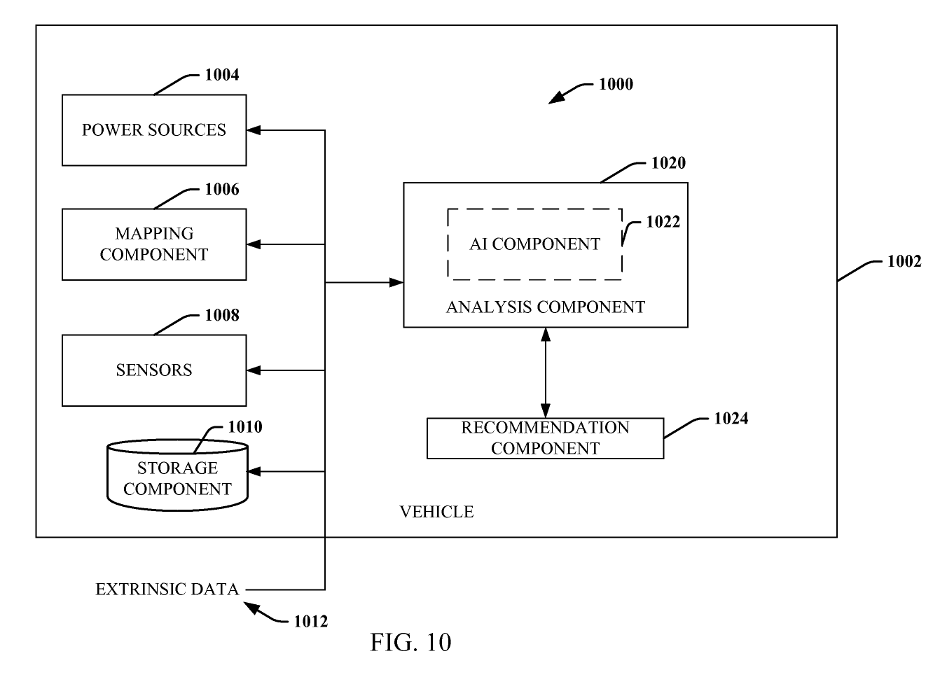

FIG. 10 discloses a system 1000 for implementation of an efficient operation policy that allows for recommendation of different routes. Thrust of a vehicle 1002 is commonly supplied by power sources 1004 of the vehicle. The power sources 1004 can be a various sources and commonly employ a form of alternative energy. However, it is possible that the power sources 1004 be a single source. A mapping component 1006 can obtain information that relates to an expected destination and route of the vehicle 1002 and estimate a route in which the vehicle 1002 will travel. Sensors 1008 observe information that concerns operation of the vehicle 1002. A storage component 1010 holds information relevant to determination of an operation policy for the vehicle 1002. Extrinsic information 1012 can also enter the vehicle 1002 and be used in the determination of an efficient operation policy.

An analysis component 1020 can function to evaluate collected data and based on the evaluation, an operation policy is determined or inferred for the vehicle 1002. To make a determination or inference as to what policies should be applied, the analysis component 1020 can use an artificial intelligence component 1022. Using the artificial intelligence component 1022, there can use different types of analysis to make the determination or inference.

A recommendation component 1024 can suggest to an operator of the vehicle various route based on specific constraints. For example, the recommendation component can suggest to the operator various routes of which the operator can select. For example, the recommendation component can suggest a route that minimizes distance, maximizes efficiency, and maximizes speed. The operator commonly selects one of these routes. For each route the analysis component 1020 determines an operation policy in consideration of a relevant constraint (e.g. minimizing distance). A determined operation policy optimizes utilization of the power source in consideration of a relevant constraint (e.g., power sources are operated efficiently on a route that is a minimum distance).

According to one embodiment, the recommendation component is configured with an interaction device (e.g. a set of dials, a set of switches, a panel, a button, etc.). This allows for determination of an operation policy considering multiple constraints (e.g., 80% minimum distance, 20% maximum efficiency).

The recommendation component 1024 can be a module that considers destination, commonly asserted explicitly or inferred under uncertainty, and produces a suggested route (e.g., if an operator is going to ‘X’, I would suggest going this way . . . to save). The recommendation component 1024 makes recommendations of alternate routes in addition to the most efficient route. This information is presented on a display of the vehicle (e.g., through a navigation system, etc.), where the shortest, fastest, and most efficient (or ‘more’ efficient) could be displayed separately (e.g., the ‘green route’ is fastest, the ‘red route’ is more efficient, etc). In one embodiment, the efficiency is weighted into the directions given depending on known user preferences (e.g., the assessed preferences of a user that are encoded in a system from previous engagements of the vehicle).

The recommendation component 1024 operates in conjunction with the analysis component 1020 that supplies a policy for optimization of a constraint in addition to utilization of power sources. For example, there can be a desire for the vehicle 1002 to travel on a route that is the fastest. The analysis component 1020 can supply a policy for optimized utilization of energy sources while following a constraint of traveling on a route that is the fastest.

According to one embodiment, the sensors 1008 gather information relating to operation of the vehicle 1002 and the power source 1004. The mapping component 1006 can estimate several routes that the vehicle 1002 will take where each route is a function of at least one constraint and these routes can be presented to an operator (e.g., a most efficient route, a fastest route, a shortest route, 50% shortest/50% fastest, etc.). The recommendation component 1024 presents these routes, or a single route, to a user and the user can select one of the routes. Based on user route selection information, the analysis component applies a set of policies to facilitate optimizing utilization of the power sources (e.g., a policy for optimizing the power source while allowing the vehicle to travel the fastest on the fastest route).

In another embodiment, the recommendation component 1024 allows for interaction with the user in route and policy determination. For example, the recommendation component 1024 can present a single route to the operator of the vehicle. The operator can modify constraints by engaging a set of interaction devices. As the operator modifies to the constraints (e.g., changes constraint of ‘going fast’ from 25% importance to 50% importance), a presented route can change in real time.

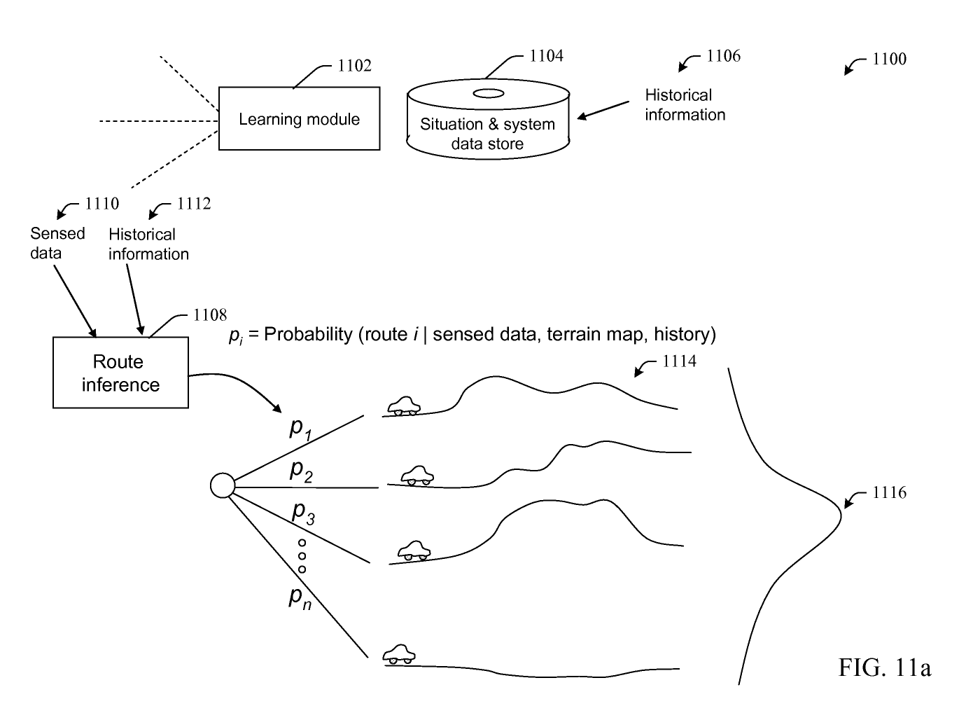

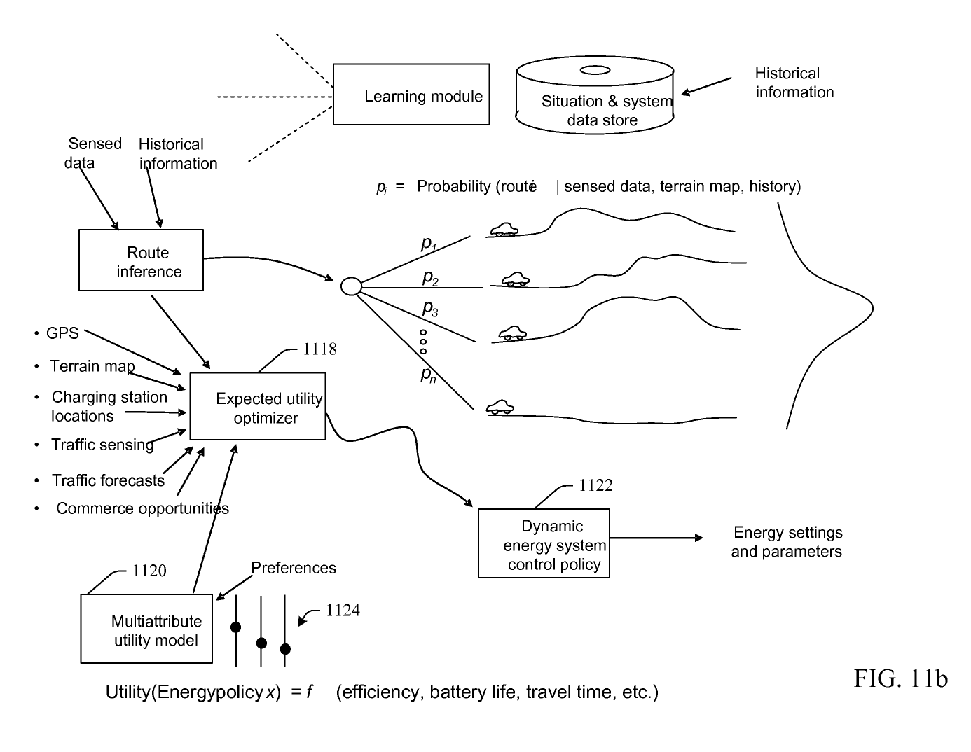

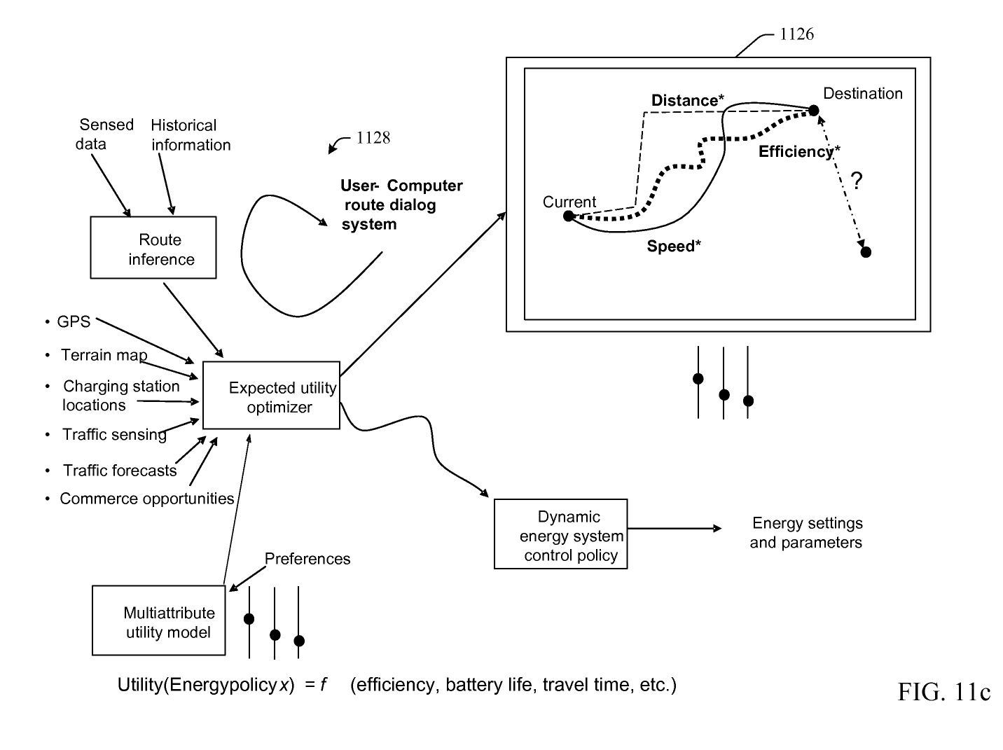

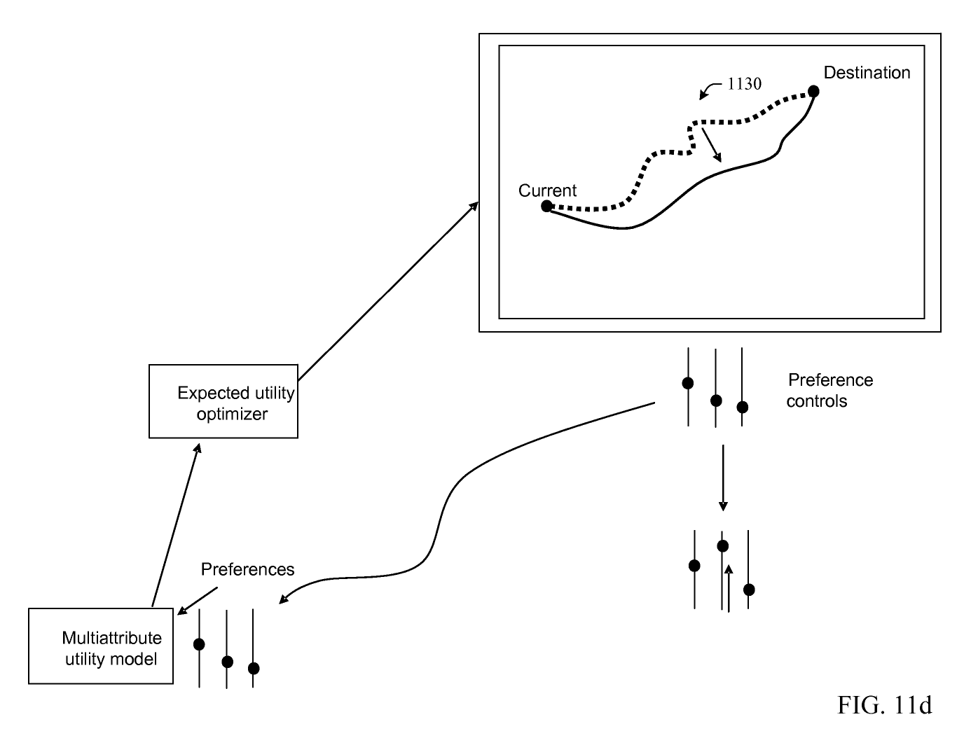

FIG. 11a through FIG. 11d discloses an example system 1100 in accordance with aspects of the subject specification. These figures can represent the interior workings of the AI component 1022 of FIG. 10 as well as operations of the recommendation component 1024 of FIG. 10. FIG. 11a discloses a first part of an example system 1100 in accordance with aspects of the subject specification. A learning module 1102 and storage component 1104 that relies on historical information 1106 communicate to allow for route inference (e.g., estimation on what route will be taken by a vehicle). The learning module 1102 gathers data concerning the operation of a vehicle that can be transferred into a route inference 1308. Furthermore, the storage component 1104 that contains historical information that is used in route inference.

The route inference 1108 takes sensed data 1110 and historical information 1112 and determines probability that certain routes 1114 will be taken by a vehicle that contains the system 1100. Different routes are shown ranging from 1-n; where n can be the number of routes the user could take up to a certain probability. There can also be a probability 1116 (e.g., a Gaussian probability) as to what routes will be taken. For example, there are four routes shown: P₁, P₂, P₃, and Pn. Each route has a probability, p, that the vehicle will travel on the route. The probability is based on a plethora of information, which can include sensed data, terrain maps, history, etc.

FIG. 11b discloses a second part of an example system 1100 in accordance with aspects of the subject specification. An expected utility optimizer 1118 takes a large amount of related information (e.g., global positioning system information, terrain map, changing station locations, traffic sensing, commerce opportunities, etc.) and multi-attribute utility model information 1120 (e.g., vehicle operator preferences) to create a dynamic energy system control policy 1122. The control policy 1122 assists in how power sources of a vehicle operate.

An operator of a vehicle can adjust settings for the multi-attribute utility model 1120 with a set of adjusters 1124. For example, the operator can indicate that a route should be taken that has a short distance and it does not matter an efficiency of the route. For example, the operator can place one adjuster low (e.g. an efficiency adjuster) and one adjuster high (e.g. distance adjuster). Based on user preferences set by the adjusters 1124, the expected utility optimizer can determine a policy.

FIG. 11c discloses a third part of an example system 1100 in accordance with aspects of the subject specification. There can be a display component 1126 that can present multiple routes to a user based on specific constraints. For example, routes can be presented that maximize efficiency, maximize speed, minimize distance, etc. Furthermore, there can be estimation as to the destination that the vehicle is going to travel. The operator can interact with the display component 1126 to change the anticipated destination. There can also be an implementation of a user-computer route dialog system 1128 that allows for communication between an operator and the route inference and/or expected utility optimizer.

For example, there are three routes presented to a user show in FIG. 11c (e.g., through the recommendation component 1024 of FIG. 1): one route for distance, one for speed, and one for efficiency. The routes can be derived from various information sources (e.g., user settings, gathered information, historical information, etc.). In this example, the distance importance setting can be at 60%, the speed setting can be at 20%, and the efficiency setting can be at 15%. Three routes can be shown taking into account user preferences in addition to other information.

FIG. 11d discloses a fourth part of an example system 1100 in accordance with aspects of the subject specification. This is similar to what is shown in FIG. 11c; however, here there is a single route shown that can be adjusted by an operator in real time. An operator can modify preferences and the route 1300 can change as the preferences change. This can show to a user how he/she would travel based on designed preferences. For example, as an operator changes preference levels (e.g., speed, distance, efficiency), the route displayed can change in real time to allow an operator to understand how changes impact a route. An analysis component (e.g., 1020 of FIG. 10) can create an efficient operation policy for a route selected by an operator.

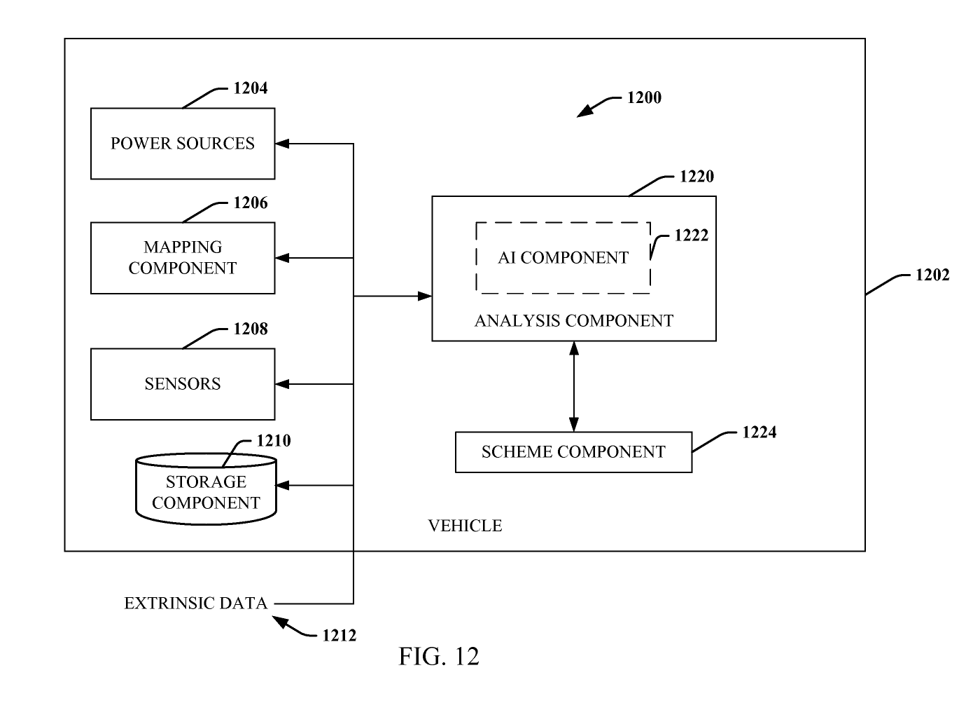

FIG. 12 discloses a system 1200 for implementation of an efficient operation policy that allows for recommendation of different routes. Thrust of a vehicle 1202 is commonly performed by power sources 1204 of the vehicle. The power sources 1204 can be a variety of different sources and commonly employ a form of alternative energy. A mapping component 1206 can gather information relating to an expected destination and route of the vehicle 1202 and estimate a route in which the vehicle 1202 will travel. Sensors 1208 gather information that relate to operation of the vehicle 1202. A storage component 1210 holds information relevant to determination of an operation policy for the vehicle 1202. Extrinsic information 1212 can also enter the vehicle 1202 and be used in the determination of an efficient operation policy.

An analysis component 1220 can function to evaluate collected data and based on the evaluation, an operation policy is determined or inferred for the vehicle 1202. To make a determination or inference as to what policies should be applied, the analysis component 1220 can use an artificial intelligence component 1222. Using the artificial intelligence component 1222, there can use different types of analysis to make the determination or inference.

A scheme component can assist in creating a route in conjunction with a schedule for energizing power sources 1204 of the vehicle 1202. For example, the vehicle can be traveling from New York City to Chicago. On the way, the vehicle will need to stop to be energized (e.g., recharge with electric power, fill with natural gas, fill with gasoline and hydrogen, etc.). Furthermore, a vehicle operator can enjoy ice hockey. The scheme component 1224 can assist in creating a route for the vehicle that has the vehicle stop in Buffalo to watch a hockey game.

The hockey arena at the game can include discount energizing with the admission price to the hockey game. Therefore, it can be beneficial for the vehicle to stop at the arena. This allows the operator to be entertained, the operator to energize the vehicle at a lower price, and the arena to sell both the energizing service as well as the admission ticket. The scheme component 1224 can also configure a route to be in line with a schedule. For example, the schedule can attempt to have the operator is in Buffalo in time for the hockey game.

The scheme component 1224 creates a plan for energizing power components in conjunction with optimizing utilization of the power sources. Given time it takes to charge, refill, etc. power systems, there can be an inference for time and sources that will be available at different stops (e.g., stops for other reasons (a power-charging center at a shopping mall)). The scheme component 1224 can compute ideal charging plans (e.g., for all-electric systems, for hybrid gasoline-electric systems, etc.) that fit in with an operator's schedule of activities with lowest amounts of waiting just for the power). There can be adjusting of an operation policy such as to take the planned activities of a user into consideration when controlling the details of a power policy on a trip (e.g., if an operator is traveling from Seattle to Portland and will stop for souvenirs along the way, then a stop can be planned near a souvenir shop). This can include not just watching and optimizing, but figuring out when to recommend that a user stop (e.g., to take advantage of a need, so as to gain access to a power-charging opportunity.

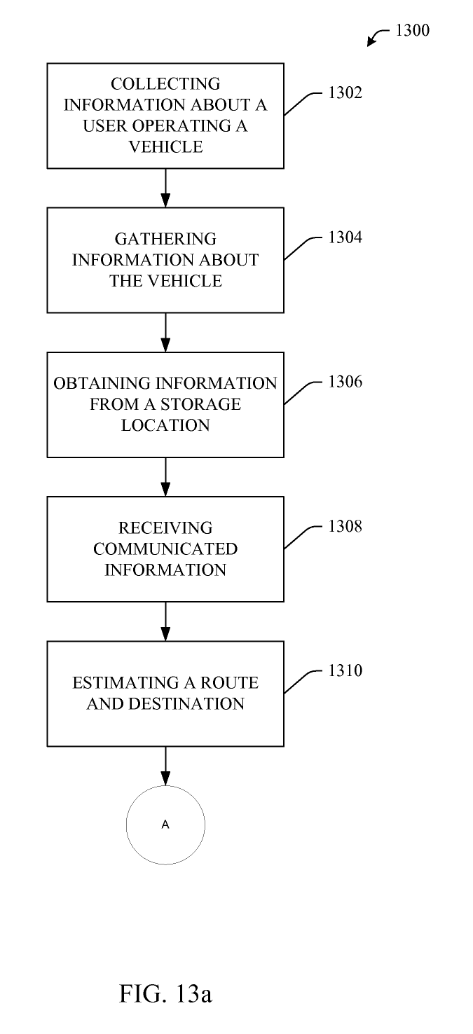

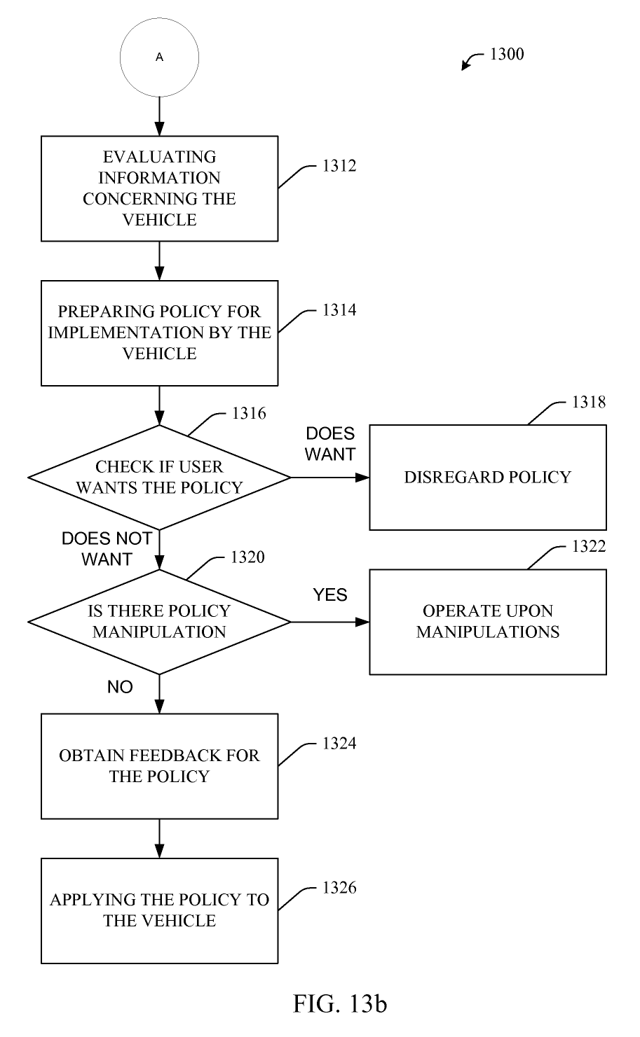

FIG. 13a and FIG. 13b disclose an example methodology 1300 implementing aspects of the subject specification. Information is gathered as to a user that will operate the vehicle 1302. For example, a vehicle can be owned by a family where four members of the family can legally operate the vehicle. Each family member likely has individual operation characteristics that should be taken into account when determining an efficient operation policy.

Collecting information about the specific user that will operate the vehicle 1302 can be important in implementing an efficient operation policy. For example, one operator of a vehicle can be a sixteen-year old female who recently obtained her driving license. Due to her inexperience, the sixteen-year old can operate the vehicle in a different manner then her forty-six-year old mother. Therefore, this information is gathered to allow for the determination of an accurate and more efficient operation policy.

A variety of information is gathered about a vehicle upon which a policy will operate 1304. For example, parameters about a size of a storage cell that stores power for operation of the vehicle can be gathered. According to one embodiment, this information is saved in a storage component and used the next time a policy is determined or inferred.

In another embodiment, the information is gathered each time a policy is to be created. One reason for this is that there can be modification to the vehicle since the last time a policy was determined. This can be both intentional and unintentional modification. For example, as an intentional modification, a user can add a device to the vehicle in order to increase the horsepower of the vehicle. This will change how the vehicle operates and thus change the configuration of an operation policy. Therefore, it would be beneficial to obtain new information since old information could not be accurate. In another example, as an unintentional modification, each time a moving part operates, there can be changes in how the moving part operates (e.g., a spark plug can fire at a different rate after a specific number of uses). Therefore, it can be useful to have recent information to determine a more efficient operation policy.

In addition, a policy can be determined taking into account previous operations of the vehicle. Commonly, information relating to previous operations of the vehicle is saved in a storage location. Therefore, information is obtained from the storage location 1306. For example, an operator of the vehicle can have certain characteristics when operating the vehicle. The operator can take actions that generally use more fuel then necessary. This information can be beneficial in determining an efficient operation policy.

In addition to collecting information about the vehicle and obtaining information from a storage location about previous operations, information can be obtained by communication with other devices 1308. An information collection component can receive information from other devices where the information can be relevant in deriving an operation policy.

For example, there can be communication with a central server that has information about local platoons that are available that the vehicle can join. When determining a policy, this information can allow the policy to take into account platoons the vehicle can join. In another example, there can be communication with a satellite that contains fuel advertisement information. There can be fuel locations that advertise a free charge if an operator spends a specific amount of time at a specific mall. A policy can be determined that takes this information into consideration.

Once information is gathered, there is an estimation of a route and destination in which the vehicle can take 1310. Oftentimes it is not known what route the vehicle will take. However, there can be difficulties in asking an operator what route he/she would like to take. Based on information obtained in other actions, a route and destination can be estimated without interaction from the operator of the vehicle.

For example, the time of route estimation can be 9:50 a.m. on a Sunday. Information can be gathered that the vehicle is located at an operator's home. On each of the past seventy Sundays at about this time, the operator has taken the vehicle to a place of worship. Based on this information (e.g., information of current situation and of previous experience), there can be an estimation that the vehicle will travel from the operator's home to the place of worship.

There is an evaluation of information concerning the vehicle 1312. Commonly the evaluation is at least in part to extrinsic information. For example, the evaluation can be of a projected route and or/destination of the vehicle or an estimated operation based on previous engagements of the vehicle. The evaluation can be performing a utility-based evaluation in connection with selecting at least one vehicle operation policy, wherein cost of making an incorrect decision is considered as part of the evaluation. Furthermore, the evaluation can be employing statistical or probabilistic-based evaluation in connection with inferring an optimal power source utilization policy as a function of available power sources, state of the power sources, vehicle state, and user state or preferences.

A resolved policy is prepared for implementation upon the vehicle 1314. Actions of the methodology can take place on a generic component not specifically designed for a specific vehicle. The generic device can be coupled to different types of vehicles/For example the generic device can couple to an automobile of brand ‘Q’, then couple to a powerboat of brand ‘R’, then couple to an automobile of brand ‘S’.

This capability can make it important to prepare an operation policy for use by a specific brand and/or type of vehicle. For example, the automobile of brand ‘Q’ can quickly process an operation policy formatted in programming code ‘C’ while automobile of brand ‘S’ can quickly process an operation policy formatted in programming code ‘D’. Preparing the operation policy for implementation by the vehicle can allow for faster operation. For example, preparing the policy for implementation upon the vehicle can include formatting the operation policy to a programming code that can be quickly processed. This can be preparing the operation policy for implementation upon the vehicle.

A check can take place to determine if an operator of the vehicle wants an efficient operation policy to operate 1316. For example, an efficient operation policy could lower the performance of the vehicle and an operator could not want a drop in performance. Therefore, the operation policy can be disregarded 1318. If the policy is disregarded 1318, the vehicle can operate in a number of different manners. For example, the vehicle can have a default operation policy or the vehicle can operate without taking into account an operation policy. If the operator wants to implement the operation policy, then the methodology continues to action 1320.

An operator can attempt to manipulate specific attributes of the operation policy 1320. For example, the operator can desire not to allow the vehicle to operate below a certain threshold (e.g., the vehicle should at no point have fuel efficiency below one mile per gallon). This manipulation can be operated upon 1322, which can include a number of different actions. For example, the manipulation can be followed, disregarded, a record of the manipulation can be saved, etc.

There are instances in which a manipulation is not followed. For example, an individual can make a policy manipulation that can be illegal (e.g., operate the vehicle at above one-hundred miles per hour, where the speed limit is thirty-five miles per hour). The methodology can practice in a configuration to reject illegal operations. Therefore, the policy can be rejected, which can still be considered an operation upon the manipulation. While not shown, once operation upon manipulations is complete, the methodology can be re-engaged, for example the methodology can continue between actions 1320 and 1322. Feedback concerning the operation policy can be obtained 1324. This is similar to the check that was performed at action 1316. However, the main difference is this allows for more interaction with the operator. According to one embodiment, a plurality of different operation policies is presented to a user. A user selects one policy and disregards the other policies. This is considered feedback and it is possible to make a record of the feedback provided by the operator. There is applying at least one operation policy for efficient resource consumption of the vehicle 1326. There can be applying at least one operation policy that seeks to maximize or minimize an objective function that includes a consideration of enhancing the efficiency of overall energy systems of a vehicle, wherein the operation policy is derived at least in part from the evaluation of the extrinsic information.

Commonly, the operation policy is derived at least in part from the evaluation of extrinsic information concerning operation of the hybrid vehicle. There can be applying at least one operation policy is a function of costs associated with replenishing a subset of the power sources. Also, there can be applying at least one operation policy is a function of an expected travel route. In addition, there can be applying of at least one operation policy is a function of previous engagements of the hybrid vehicle.

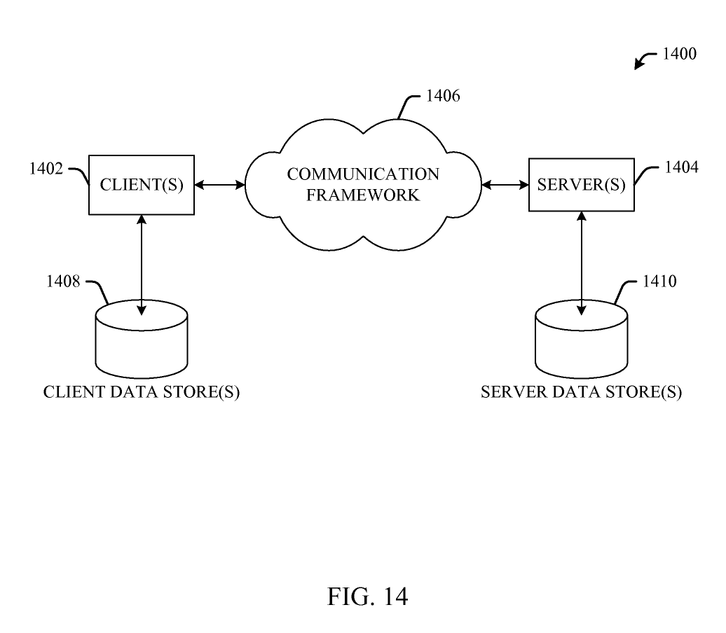

Referring now to FIG. 14, there is illustrated a schematic block diagram of a computing environment 1400 in accordance with the subject specification. The system 1400 includes one or more client(s) 1402. The client(s) 1402 can be hardware and/or software (e.g., threads, processes, computing devices). The client(s) 1402 can house cookie(s) and/or associated contextual information by employing the specification, for example.

The system 1400 also includes one or more server(s) 1404. The server(s) 1404 can also be hardware and/or software (e.g., threads, processes, computing devices). The servers 1404 can house threads to perform transformations by employing the specification, for example. One possible communication between a client 1402 and a server 1404 can be in the form of a data packet adapted to be transmitted between two or more computer processes. The data packet may include a cookie and/or associated contextual information, for example. The system 1400 includes a communication framework 1406 (e.g., a global communication network such as the Internet) that can be employed to facilitate communications between the client(s) 1402 and the server(s) 1404.

Communications can be facilitated via a wired (including optical fiber) and/or wireless technology. The client(s) 1402 are operatively connected to one or more client data store(s) 1408 that can be employed to store information local to the client(s) 1402 (e.g., cookie(s) and/or associated contextual information). Similarly, the server(s) 1404 are operatively connected to one or more server data store(s) 1410 that can be employed to store information local to the servers 1404.

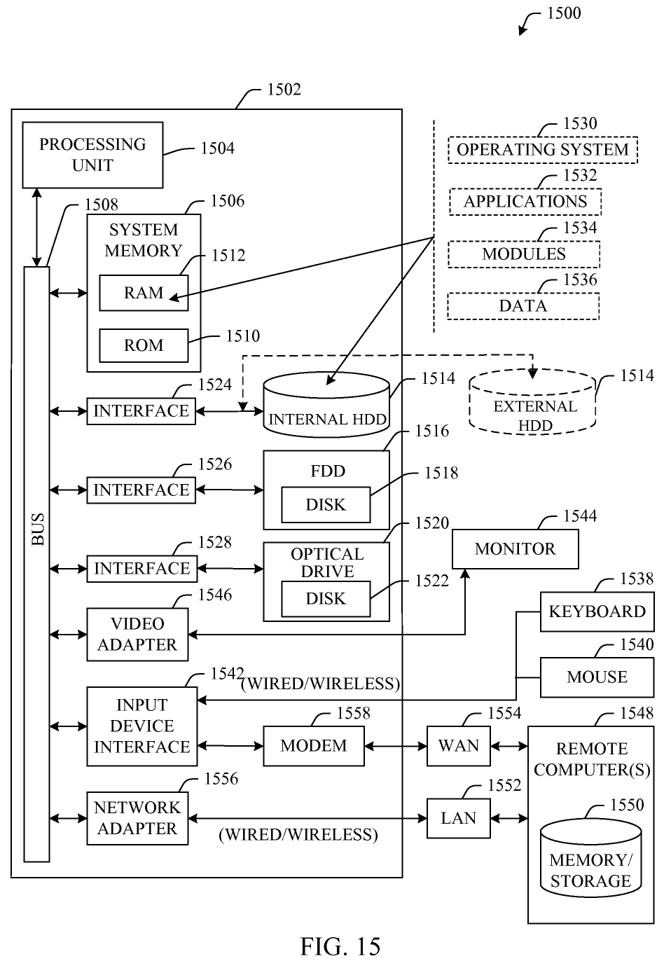

Referring now to FIG. 15, there is illustrated a block diagram of a computer operable to execute the disclosed architecture. In order to provide additional context for various aspects of the subject specification, FIG. 15 and the following discussion are intended to provide a brief, general description of a suitable computing environment 1500 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 15, the example environment 1500 for implementing various aspects of the specification includes a computer 1502, the computer 1502 including a processing unit 1504, a system memory 1506 and a system bus 1508. The system bus 1508 couples system components including, but not limited to, the system memory 1506 to the processing unit 1504. The processing unit 1504 can be any of various commercially available processors. Dual microprocessors and other multi-processor architectures may also be employed as the processing unit 1504.

The system bus 1508 can be any of several types of bus structure that may further interconnect to a memory bus (with or without a memory controller), a peripheral bus, and a local bus using any of a variety of commercially available bus architectures. The system memory 1506 includes read-only memory (ROM) 1510 and random access memory (RAM) 1512. A basic input/output system (BIOS) is stored in a non-volatile memory 1510 such as ROM, EPROM, EEPROM, which BIOS contains the basic routines that help to transfer information between elements within the computer 1502, such as during start-up. The RAM 1512 can also include a high-speed RAM such as static RAM for caching data.

The computer 1502 further includes an internal hard disk drive (HDD) 1514 (e.g., EIDE, SATA), which internal hard disk drive 1514 may also be configured for external use in a suitable chassis (not shown), a magnetic floppy disk drive (FDD) 1516, (e.g., to read from or write to a removable diskette 1518) and an optical disk drive 1520, (e.g., reading a CD-ROM disk 1522 or, to read from or write to other high capacity optical media such as the DVD). The hard disk drive 1514, magnetic disk drive 1516 and optical disk drive 1520 can be connected to the system bus 1508 by a hard disk drive interface 1524, a magnetic disk drive interface 1526 and an optical drive interface 1528, respectively. The interface 1524 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1502, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 1512, including an operating system 1530, one or more application programs 1532, other program modules 1534 and program data 1536. All or portions of the operating system, applications, modules, and/or data can also be cached in the RAM 1512. It is appreciated that the specification can be implemented with various commercially available operating systems or combinations of operating systems.

A user can enter commands and information into the computer 1502 through one or more wired/wireless input devices, e.g. a keyboard 1538 and a pointing device, such as a mouse 1540. Other input devices (not shown) may include a microphone, an IR remote control, a joystick, a game pad, a stylus pen, touch screen, or the like. These and other input devices are often connected to the processing unit 1504 through an input device interface 1542 that is coupled to the system bus 1508, but can be connected by other interfaces, such as a parallel port, an IEEE 1394 serial port, a game port, a USB port, an IR interface, etc.

A monitor 1544 or other type of display device is also connected to the system bus 1508 via an interface, such as a video adapter 1546. In addition to the monitor 1544, a computer typically includes other peripheral output devices (not shown), such as speakers, printers, etc.

The computer 1502 may operate in a networked environment using logical connections via wired and/or wireless communications to one or more remote computers, such as a remote computer(s) 1548. The remote computer(s) 1548 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1550 is illustrated. The logical connections depicted include wired/wireless connectivity to a local area network (LAN) 1552 and/or larger networks, e.g. a wide area network (WAN) 1554. Such LAN and WAN networking environments are commonplace in offices and companies, and facilitate enterprise-wide computer networks, such as intranets, all of which may connect to a global communications network, e.g., the Internet.

When used in a LAN networking environment, the computer 1502 is connected to the local network 1552 through a wired and/or wireless communication network interface or adapter 1556. The adapter 1556 may facilitate wired or wireless communication to the LAN 1552, which may also include a wireless access point disposed thereon for communicating with the wireless adapter 1556.

When used in a WAN networking environment, the computer 1502 can include a modem 1558, or is connected to a communications server on the WAN 1554, or has other means for establishing communications over the WAN 1554, such as by way of the Internet. The modem 1558, which can be internal or external and a wired or wireless device, is connected to the system bus 1508 via the serial port interface 1542. In a networked environment, program modules depicted relative to the computer 1502, or portions thereof, can be stored in the remote memory/storage device 1550. It will be appreciated that the network connections shown are example and other means of establishing a communications link between the computers can be used.

The computer 1502 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a set of sensors that monitor and collect data relating to operation of a vehicle, and at least one associated power source for driving the vehicle; and
an analysis component that analyzes the collected data, and applies a set of policies to facilitate optimizing utilization of the power source as a function of extrinsic information apart from vehicle related information.

2. The system of claim 1, wherein the analysis component applies a vehicle operation policy as a function of an expected travel route.

3. The system of claim 2, further comprises a mapping component that provides information in connection with directions to a destination, and associated terrain.

4. The system of claim 2, further comprising a recommendation component that presents at least one route to a user, wherein the route is a function of at least one constraint.

5. The system of claim 1, the analysis component selecting a set of vehicle operation policies as a function of information relating to operation of at least one other vehicle.

6. The system of claim 1, further comprising an artificial intelligence component that employs a probabilistic analysis in connection with inferring an optimal power source utilization policy as a function of potential routes, road context, available power source, state of the power source, vehicle state, user state and/or user preferences.

7. The system of claim 1, further comprising a storage component that stores historical data relating to a power system and/or contextual data drawn from the operation of one or more vehicles.

8. The system of claim 1, the analysis component performs an optimization via an expected-utility analysis in connection with selecting and/or modifying a set of vehicle operation policies, wherein the cost and/or benefits of alternate actions are considered as part of the analysis.

9. The system of claim 1, further comprising a login component that obtains data concerning creatures in the vehicle.

10. The system of claim 1, the analysis component selecting a set of vehicle operation policies as a function of costs associated with replenishing a subset of the power source.

12. The system of claim 1, wherein the analysis component applies a vehicle operation policy as a function of previous engagements of the vehicle.

13. The system of claim 1, further comprising a scheme component that creates a plan for energizing a power source in conjunction with optimizing utilization of the power source.

14. A method, comprising:
evaluating extrinsic information concerning operation of a vehicle; and
applying at least one operation policy, wherein the operation policy is derived at least in part from the evaluation of the extrinsic information.

14. The method of claim 13, further comprising obtaining data relating to operation of a vehicle, and at least one associated power source for operation of the vehicle.

15. The method of claim 13, further comprising performing an expected-utility evaluation in connection with selecting at least one vehicle operation policy, wherein the expected costs and/or benefits of making an incorrect decision are considered as part of the evaluation.

16. The method of claim 13, further comprising employing statistical or probabilistic-based evaluation in connection with inferring an optimal power source utilization policy as a function of available power source, state of the power source, a terrain map, traffic flow, vehicle state, and/or user state or preferences.

17. The method of claim 13 wherein applying at least one operation policy is a function of costs associated with replenishing a subset of the power source.

18. The method of claim 13, wherein applying at least one operation policy is a function of an expected travel route.

19. The method of claim 13, wherein applying of at least one operation policy is a function of previous engagements of the vehicle.

20. A system, comprising:
means for gathering data about at least one previous engagement of a vehicle;
means for inferring a probability distribution over a route and destination that the vehicle will use; and
means for determining an operation policy for efficient use of at least one power source of the vehicle based at least in part on gathered data about at least one previous engagement and/or the estimated route and destination.
